(19) United States
(12) Patent Application Publication
(10) Pub. No.: US 2011/0285959 A1
(43) Pub. Date: Nov. 24, 2011

(54) REDUCTION OF IMAGE JUMP

(75) Inventors: Amitava Gupta, Roanoke, VA (US); Ronald D. Blum, Roanoke, VA (US)

(73) Assignee: PixelOptics, Roanoke, VA (US)

(21) Appl. No.: 13/114,871

(22) Filed: May 24, 2011

Related U.S. Application Data
(60) Provisional application No. 61/347,562, filed on May 24, 2010.

(51) Int. Cl. G02C 7/06; G02B 3/10

(52) U.S. Cl. 351/169; 359/721; 351/168

(57) ABSTRACT

Embodiments of the present invention disclosed herein are directed to apparatuses and systems for reducing the image jump from a dynamic lens component. The apparatuses and systems disclosed herein may be used in ophthalmic devices, such as eye glasses or contact lenses, as well as any other suitable application. Embodiments provide a first apparatus that comprises a dynamic power zone having a periphery. The first apparatus further comprises a static power zone in optical communication with at least a portion of the dynamic power zone. The static power zone has a negative optical power at a first portion of the periphery of the dynamic power zone.

### CROSS-REFERENCES TO RELATED APPLICATIONS

This application claims benefit under 35 U.S.C. §119(e) of U.S. provisional patent application No. 61/347,562, filed on May 24, 2010, the entire disclosure of which is incorporated herein by reference for all purposes.

### BACKGROUND

Presbyopia is the loss of accommodation of the crystalline lens of the human eye that often accompanies aging. This loss of accommodation results in an inability to focus on near distance objects. The standard tools for correcting presbyopia are multifocal ophthalmic lenses. A multifocal lens is a lens that has more than one focal length (i.e., optical power) for correcting focusing problems across a range of distances. Multifocal ophthalmic lenses work by means of a division of the lens's area into regions of different optical powers. Typically, a relatively large area located in the upper portion of the lens corrects for far, distance vision errors, if any. A small area located in the bottom portion of the lens provides additional optical power for correcting near distance vision errors caused by presbyopia. A multifocal lens may also contain a small region located near the middle portion of the lens which provides additional optical power for correcting intermediate distance vision errors.

The transition between the regions of different optical power may be either abrupt, as is the case for bifocal and trifocal lenses, or smooth and continuous, as is the case with Progressive Addition Lenses. Progressive Addition Lenses are a type of multifocal lenses that comprise a gradient of continuously increasing positive dioptric optical power from the beginning of the far distance viewing zone of the lens to the near distance viewing zone in the lower portion of the lens. This progression of optical power generally starts at approximately what is known as the fitting cross or fitting point of the lens and continues until the full add power is realized in the near distance viewing zone and then plateaus. Conventional and state-of-the-art Progressive Addition Lenses utilize a surface topography on one or both exterior surfaces of the lens shaped to create this progression of optical power. Progressive Addition Lenses are known within the optical industry when plural as PALS or when singular, as a PAL. PAL lenses are advantageous over traditional bifocal and trifocal lenses in that they can provide a user with a lineless, cosmetically pleasing multifocal lens with continuous vision correction when focusing on objects at a far distance to objects at a near distance or vice versa.

While PALs are now widely accepted and in vogue within the USA and throughout the world as a correction for presbyopia, they also have serious vision compromises. These compromises include but are not limited to unwanted astigmatism, distortion, and perceptual blur. These vision compromises may affect a user's horizontal viewing width, which is the width of the visual field that can be seen clearly as a user looks from side to side while focused at a given distance. Thus, PAL lenses may have a narrow horizontal viewing width when focusing at an intermediate distance, which can make viewing a large section of a computer screen difficult. Similarly, PAL lenses may have a narrow horizontal viewing width when focusing at a near distance, which can make viewing the complete page of a book or newspaper difficult. Far distance vision may be similarly affected. PAL lenses may also present a difficulty to a wearer when playing sports due to the distortion of the lenses. Additionally, because the optical add power is placed in the bottom region of the PAL lens, the wearer must tilt his or her head back to make use of this region when viewing an object above his or her head which is located at a near or intermediate distance. Contrastingly, when a wearer is descending stairs and assumes a downward glance, a near distance focus is provided by the lens instead of the far distance focus necessary to see one's feet and the stairs clearly. Thus, the wearer's feet will be out of focus and appear blurred. In addition to these limitations, many wearers of PALs experience an unpleasant effect known as visual motion (often referred to as “swim”) due to the unbalanced distortion that exists in each of the lenses. In fact, many people refuse to wear such lenses because of this effect.

When considering the near optical power needs of a presbyopic individual, the amount of near optical power required is directly related to the amount of accommodative amplitude (near distance focusing ability) the individual has left in his or eyes. Generally, as an individual ages the amount of accommodative amplitude decreases. Accommodative amplitude may also decrease for various health reasons. Therefore, as one ages and becomes more presbyopic, the optical power needed to correct one's ability to focus at a near viewing distance and an intermediate viewing distance becomes stronger in terms of the needed dioptric optical add power. By way of example only, an individual 45 years old may need +1.00 diopters of near viewing distance optical power to see clearly at a near point distance, while an individual 80 years old may need +2.75 diopters to +3.00 diopters of near viewing distance optical power to see clearly at the same near point distance. Because the degree of vision compromises in PAL lenses increases with dioptric optical add power, a more highly presbyopic individual will be subject to greater vision compromises. In the example above, the individual who is 45 years of age will have a lower level of distortion associated with his or her lenses than the individual who is 80 years of age. As is readily apparent, this is the complete opposite of what is needed given the quality of life issues associated with being elderly, such as frailty or loss of dexterity. Prescription multifocal lenses that add compromises to vision function and inhibit safety are in sharp contrast to lenses that make lives easier, safer, and less complex.

Dynamic lenses, such as those that utilize electro-active segments, have been used to provide added plus optical power in ophthalmic lenses, as well as in other optical systems and in various other fields. In many instances, dynamic segments or lenses providing additional plus optical power have several advantages relative to static optical power segments or surfaces like those of progressive addition surfaces. For example, they may be turned off (inactive state) when not viewing near objects, thus eliminating the distortion created by progressive addition lens designs. When not activated, these dynamic lenses do not have the image jump created by static bifocal segments. Dynamic lenses may be used either by themselves, resulting in an electronic bifocal lens, or in optical communication with a static multifocal optic, such as a bifocal or a progressive addition surface. In these cases, the added plus power provided by the dynamic lens is less than the total add power required in the optical device because the static segment also provides a part of the add power.

An optical device comprising a dynamic lens (i.e. dynamic power zone or region), such as an electro-active segment, in optical communication with that of a static progressive addition lens or surface can have lower levels of unwanted astigmatism, less distortion, wider fields of clear vision, and can provide an improved ability to see the floor more clearly when compared to a progressive addition lens of equal optical total add and distance power. However, there can be a perceived image jump when the dynamic power zone (e.g. an electro-active segment) is activated (e.g. turned on) and when the eye crosses the border of the electro-active segment when looking from far to near. The image jump can occur due to the optical discontinuity that occurs when the dynamic power zone is activated, providing an increase of add optical power.

Therefore, there is a need for an optical design, and resulting lens that allows for such a combination of a dynamic power zone (e.g. electro-active segment) in optical communication with a static add power surface, segment or zone, like that of, by way of example only, a progressive addition lens surface, so that the resulting lens provides less image jump (e.g. prism and magnification) around the periphery of the dynamic power segment or zone when the dynamic power zone is turned on and provides optical add power, while at the same time may provide the benefits of less swim, wider zones of clear vision.

### BRIEF SUMMARY

Embodiments of the present invention disclosed herein are directed to apparatuses and systems for reducing the image jump from a dynamic lens component. The apparatuses and systems disclosed herein may be used in ophthalmic devices, such as eye glasses or contact lenses, as well as any other suitable application.

Embodiments provide a first apparatus that comprises a dynamic power zone having a periphery. The first apparatus further comprises a static power zone in optical communication with at least a portion of the dynamic power zone. The static power zone has a negative optical power at a first portion of the periphery of the dynamic power zone.

In some embodiments, in the first apparatus described above, the static power zone has a positive optical power approximately at the center of the dynamic power zone. In some embodiments, the optical power profile of the static power zone may be asymmetric. In some embodiments, the static power zone has a minimum optical power at a distance that is within 5 mm from the periphery of the dynamic power zone in a direction perpendicular to the periphery. In some embodiments, the static power zone has a minimum optical power at a distance that is within 1 mm from the periphery of the dynamic power zone in a direction perpendicular to the periphery.

In some embodiments, in the first apparatus as described above, the optical power of a portion of the static power zone that is not in optical communication with the dynamic power zone varies continuously in a direction that is perpendicular to the periphery of the dynamic power zone until the optical power reaches a value of zero Diopters. In some embodiments, the optical power of a portion of the static power zone that is not in optical communication with the dynamic power zone is asymptotic.

In some embodiments, in the first apparatus as described above, the first portion of the periphery of the dynamic power zone where the static power zone has a negative optical power comprises a portion of the periphery of the dynamic power zone between a near and a far distance viewing zone. In some embodiments, the first portion of the periphery of the dynamic power zone where the static power zone has a negative optical power includes only a portion of the periphery of the dynamic power zone between a near and a far distance viewing zone. In some embodiments, the first portion of the periphery of the dynamic power zone where the static power zone has a negative optical power comprises the entire periphery of the dynamic power zone.

In some embodiments, in the first apparatus as described above, the dynamic power zone has a first optical power in an active state and a second optical power in an inactive state, where the second optical power is different than the first optical power. In some embodiments, the dynamic power zone comprises an electro-active segment. In some embodiments, the dynamic power zone may include a fluid lens (or a region), a gas lens, a meniscus lens, a mechanical lens, and/or a combination of an electro-active segment (such as an electro-active assembly), a fluid lens, and a mechanical lens.

In some embodiments, in the first apparatus as described above, the static power zone is aspheric. In some embodiments, the static power zone and the dynamic power zone may have a similar shape or the same shape. In some embodiments, the static power zone is elliptical in shape. In some embodiments, the static power zone and the dynamic power zone are coupled to an ophthalmic lens optic.

In some embodiments, in the first apparatus as described above, the total add power of the dynamic power zone and the static power zone at the first portion of the periphery of the dynamic power zone where the static power zone has a negative optical power is less than approximately 1 Diopter when the dynamic power zone is in an active state. Preferably, the total add power of the dynamic power zone and the static power zone at the first portion of the periphery is less than approximately 0.5 Diopters when the dynamic power zone is in an active state.

In some embodiments, in the first apparatus as described above the dynamic power zone, when in an active state, has an optical power at the first portion of its periphery that is greater than approximately 0.5 Diopters. In some embodiments, the dynamic power zone, when in an active state, has an optical power at the first portion of its periphery that is greater than approximately 1 Diopter. In some embodiments, the dynamic power zone, when in an active state, has an optical power at the first portion of the periphery that is greater than approximately 1.5 Diopters.

In some embodiments, in the first apparatus as described above, the static power zone has a minimum optical power at the first portion of the periphery of the dynamic power zone of approximately −1 Diopter. In some embodiments, the static power zone has an optical power at the first portion of the periphery of the dynamic power zone approximately within the range of −0.1 to −0.8 Diopters. In some embodiments, the static power zone may be radially symmetrical in spherical optical power. In some embodiments, the static power zone is bilaterally symmetrical in spherical optical power.

In some embodiments, in the first apparatus as described above, the static power zone provides a discontinuous change in optical power at the first portion of the periphery of the dynamic power zone. In some embodiments, the static power zone provides a continuous change in average spherical optical power and/or astigmatism at the first portion of the periphery of the dynamic power zone. In some embodiments, the static power zone comprises a progressive addition surface.

In some embodiments, in the first apparatus as described above, the static power zone has a change from positive optical power to negative optical power at a perpendicular distance from the periphery of the dynamic power zone approximately within the range of 2 to 6 mm. In some embodiments, the static power zone has a change from positive optical power to negative optical power at a perpendicular distance from the center of the dynamic power zone approximately within the range of 2-5 mm. In some embodiments, the static power zone has an optical power at the center of the dynamic power zone approximately within the range of 0.3 to 0.5 Diopters.

In some embodiments, in the first apparatus as described above, the static power zone has a prism power at the first portion of the periphery of the dynamic power zone approximately within the range of 0 to −3 prism Diopters. In some embodiments, the static power zone has a prism power at the first portion of the periphery of the dynamic power zone approximately within the range of −0.05 to −2.5 prism Diopters.

In some embodiments, the total prism power of the dynamic power zone and the static power zone at the first portion of the periphery of the dynamic power zone when the dynamic power zone is in an active state is approximately within the range of 0.1 to 1 prism Diopters. In some embodiments, the total prism power of the dynamic power zone and the static power zone at the first portion of the periphery of the dynamic power zone when the dynamic power zone is in an active state is approximately within the range of 0.3 to 0.7 prism Diopters.

In some embodiments, in the first apparatus described above, the total prism power from the dynamic power zone and the static power zone at the first portion of the periphery of the dynamic power zone when the dynamic power zone is in an active state is less than approximately 0.5 Diopters. Preferably, the total prism power is less than approximately 0.35 Diopters.

In some embodiments, in the first apparatus as described above, the maximum total add power of the static zone and the dynamic power zone when the dynamic power zone is in an active state is at least 1 Diopter. In some embodiments, the total add power is at least 1.5 Diopters.

In some embodiments, in the first apparatus as described above, the static power zone has a maximum radius of curvature that is less than approximately 6×10⁻⁴ mm⁻¹. The static power zone may have a maximum radius of curvature that is less than approximately 4×10⁻⁴ mm⁻¹. In some embodiments, the static power zone has a minimum radius of curvature that is greater than approximately −13×10⁻⁴ mm⁻¹. In some embodiments, the static power zone may have a minimum radius of curvature that is greater than approximately −10×10⁻⁴ mm⁻¹ and a maximum radius of curvature that is less than approximately 5×10⁻⁴ mm⁻¹.

In some embodiments, in the first apparatus as described above, the static power zone has a minimum sag that is greater than approximately −6×10⁻³ mm and a maximum sag that is less than approximately 6×10⁻³ mm⁻¹. In some embodiments, the static power zone has a minimum sag greater than approximately −3×10⁻³ mm and a maximum sag that is less than approximately 3×10⁻³ mm⁻¹.

In some embodiments, the first apparatus comprises an ophthalmic device. The ophthalmic device may comprise any one of spectacles (or spectacle lenses), a contact lens, an intra-ocular lens, a corneal in-lay, and a corneal on-lay.

A first ophthalmic lens is provided that comprises a dynamic electro-active segment having a first add optical power and a static addition zone having a second add optical power. The static addition zone comprises a progressive addition surface that contributes a positive optical power and a minus optical power. The static addition zone may have at least a first portion in optical communication with at least a portion of the periphery of the dynamic electro-active segment. The first portion of the static addition zone may have a negative optical power.

In some embodiments, in the first ophthalmic lens as described above, the total add optical power of the first portion of the static addition zone and the portion of the periphery of the dynamic electro-active segment, when the dynamic electro-active segment is activated, is less than 1 Diopter. Preferably, the total add optical power is less than 0.5 Diopters. In some embodiments, the static addition zone and the dynamic electro-active segment have a similar shape and are located in approximately the same location on the ophthalmic lens.

Embodiments provide apparatuses and systems that may reduce the image jump (both prism displacement and magnification) and/or astigmatism experienced when looking at or across the border between two optical zones that have different optical properties, particularly when one of those zones is dynamic. Embodiments provide a static power optical zone that has a negative optical power in optical communication with at least a portion of the periphery of a dynamic power zone (such as an electro-active segment) that has a positive optical power when activated. In this manner, the total add power of the static power optical zone and the dynamic power zone or region does not have as large a discontinuity in optical power at the periphery when the dynamic power region is activated. That is, the negative optical power provided by the static power zone effectively cancels a portion of the positive optical power that is provided by the dynamic power zone at the periphery. This reduces some of the negative optical effects experienced at the periphery of the dynamic power zone. Moreover, the static power zone may have an optical power profile such that the add power of the static power zone increases and is positive near the center of the dynamic power zone, thereby contributing positive optical power to the overall add power of the apparatus or system.

### BRIEF DESCRIPTION OF THE DRAWINGS

FIGS. 1 (a) and (b) show side views of an exemplary apparatus.

FIG. 2 shows an exemplary apparatus in accordance with embodiments.

FIG. 3 shows a graph of optical power vs. distance along the x and y axes for an exemplary apparatus.

FIGS. 4 (a)-(c) show front views of exemplary apparatuses.

FIG. 5 shows three graphs of the optical power vs. distance of portions of an exemplary apparatus.

FIG. 6 shows three graphs of the optical power vs. distance of portions of an exemplary apparatus.

FIG. 7 (a)-(c) show side views of an exemplary apparatus.

FIGS. 8-11 (a)-(h) show the results of simulations for exemplary embodiments.

FIGS. 12 (a)-(c) show exemplary multi-focal lenses in accordance with embodiments.

### DETAILED DESCRIPTION

Many ophthalmological, optometric, and optical terms are used in this application. For the sake of clarity, their definitions are listed below:

Add Power: The optical power added to the far distance viewing optical power which is required for clear near distance viewing in a multifocal lens. For example, if an individual has a far distance viewing prescription of −3.00 D with a +2.00 D add power for near distance viewing then the actual optical power in the near distance portion of the multifocal lens is −1.00 D. Add power is sometimes referred to as plus power. Add power may be further distinguished by referring to “near viewing distance add power” which refers to the add power in the near viewing distance portion of the lens and “intermediate viewing distance add power” which refers to the add power in the intermediate viewing distance portion of the lens. Typically, the intermediate viewing distance add power is approximately 50% of the near viewing distance add power. Thus, in the example above, the individual would have +1.00 D add power for intermediate distance viewing and the actual total optical power in the intermediate viewing distance portion of the multifocal lens is −2.00 D.

Approximately: Plus or minus 10 percent, inclusive. Thus, the phrase “approximately 10 mm” may be understood to mean from 9 mm to 11 mm, inclusive.

Blend Zone: An optical power transition along a peripheral edge of a lens whereby the optical power continuously transitions across the blend zone from a first corrective power, to that of a second corrective power or vice versa. Generally the blend zone is designed to have as small a width as possible. A peripheral edge of a dynamic optic may include a blend zone so as to reduce the visibility of the dynamic optic. A blend zone is utilized for cosmetic enhancement reasons and also to enhance vision functionality. A blend zone is typically not considered a usable portion of the lens due to its high unwanted astigmatism. A blend zone is also known as a transition zone.

Channel: The region of a Progressive Addition Lens defined by increasing plus optical power which extends from the far distance optical power region or zone to the near distance optical power region or zone. This optical power progression starts in an area of the PAL known as the fitting point and ends in the near distance viewing zone. The channel is sometimes referred to as the corridor.

Channel Length: The channel length is the distance measured from the fitting point to the location in the channel where the add power is within approximately 85% of the specified near distance viewing power.

Channel Width: The narrowest portion of the channel bounded by an unwanted astigmatism that is above approximately +1.00 D. This definition is useful when comparing PAL lenses due to the fact that a wider channel width generally correlates with less distortion, better visual performance, increased visual comfort, and easier adaptation for the wearer.

Contour Maps: Plots that are generated from measuring and plotting the unwanted astigmatic optical power of a Progressive Addition Lens. The contour plot can be generated with various sensitivities of astigmatic optical power thus providing a visual picture of where and to what extent a Progressive Addition Lens possesses unwanted astigmatism as part of its optical design. Analysis of such maps is typically used to quantify the channel length, channel width, reading width and far distance width of a PAL. Contour maps may also be referred to as unwanted astigmatic power maps. These maps can also be used to measure and portray optical power in various parts of the lens.

Conventional Channel Length: Due to aesthetic concerns or trends in eyewear fashion, it may be desirable to have a lens that is foreshortened vertically. In such a lens the channel is naturally also shorter Conventional channel length refers to the length of a channel in a non-foreshortened PAL lens. These channel lengths are usually, but not always, approximately 15 mm or longer. Generally, a longer channel length means a wider channel width and less unwanted astigmatism. Longer channel designs are often associated with “soft” progressives, since the transition between far distance correction and near distance correction is softer due to the more gradual increase in optical power.

Dynamic lens: A lens with an optical power which is alterable with the application of electrical energy, mechanical energy or force. Either the entire lens may have an alterable optical power, or only a portion, region or zone of the lens may have an alterable optical power. The optical power of such a lens is dynamic or tunable such that the optical power can be switched between two or more optical powers. The switching may comprise a discrete change from one optical power to another (such as going from an “off” or inactive state to an “on” or active state) or it may comprise continuous change from a first optical power to a second optical power, such as by varying the amount of electrical energy to a dynamic element. One of the optical powers may be that of substantially no optical power. Examples of dynamic lenses include electro-active lenses, meniscus lenses, fluid lenses, movable dynamic optics having one or more components, gas lenses, and membrane lenses having a member capable of being deformed. A dynamic lens may also be referred to as a dynamic optic, a dynamic optical element, a dynamic optical zone, dynamic power zone, or a dynamic optical region.

Far Distance Reference Point: A reference point located approximately 3-4 mm above the fitting cross where the far distance prescription or far, distance optical power of the lens can be measured easily.

Far Distance Viewing Zone: The portion of a lens containing an optical power which allows a user to see correctly at a far viewing distance.

Far Distance Width: The narrowest horizontal width within the far distance viewing portion of the lens which provides clear, mostly distortion-face correction with an optical power within 0.25 D of the wearer's far distance viewing optical power correction.

Far Viewing Distance: The distance to which one looks, by way of example only, when viewing beyond the edge of one's desk, when driving a car, when looking at a distant mountain, or when watching a movie. This distance is usually, but not always, considered to be approximately 32 inches or greater from the eye the far viewing distance may also be referred to as a far distance and a far distance point.

Fitting Cross/Fitting Point: A reference point on a PAL that represents the approximate location of the wearer's pupil when looking straight ahead through the lens once the lens is mounted in an eyeglass frame and positioned on the wearer's face. The fitting cross/fitting point is usually, but not always, located 2-5 mm vertically above the start of the channel. The fitting cross typically has a very slight amount of plus optical power ranging from just over +0.00 Diopters to approximately +0.12 Diopters. This point or cross is marked on the lens surface such that it can provide an easy reference point for measuring and/or double-checking the fitting of the lens relative to the pupil of the wearer. The mark is easily removed upon the dispensing of the lens to the patient/wearer.

Hard Progressive Addition Lens: A Progressive Addition Lens with a less gradual, steeper transition between the far distance correction and the near distance correction. In a hard PAL the unwanted distortion may be below the fitting point and not spread out into the periphery of the lens. A hard PAL may also have a shorter channel length and a narrower channel width. A “modified hard Progressive Addition Lens” is a hard PAL which is modified to have a limited number of characteristics of a soft PAL such as a more gradual optical power transition, a longer, channel, a wider channel, more unwanted astigmatism spread out into the periphery of the lens, and less unwanted astigmatism below the fitting point.

Intermediate Distance Viewing Zone: The portion of a lens containing an optical power which allows a user to see correctly at an intermediate viewing distance.

Intermediate Viewing Distance: The distance to which one looks, by way of example only, when reading a newspaper, when working on a computer, when washing dishes in a sink, or when ironing clothing. This distance is usually, but not always, considered to be between approximately 16 inches and approximately 32 inches from the eye. The intermediate viewing distance may also be referred to as an intermediate distance and an intermediate distance point.

Lens: Any device or portion of a device that causes light to converge or diverge. The device may be static or dynamic. A lens may be refractive or diffractive. A lens may be either concave, convex or piano on one or both surfaces. A lens may be spherical, cylindrical, prismatic or a combination thereof. A lens may be made of optical glass, plastic or resin. A lens may also be referred to as an optical element, an optical zone, an optical region, an optical power region or an optic. It should be pointed out that within the optical industry a lens can be referred to as a lens even if it has zero optical power.

Lens Blank: A device made of optical material that may be shaped into a lens. A lens blank may be finished meaning that the lens blank has been shaped to have an optical power on both external surfaces. A lens blank may be semi-finished meaning that the lens blank has been shaped to have an optical power on only one external surface. A lens blank may be unfinished meaning that the lens blank has not been shaped to have an optical power on either external surface. A surface of an unfinished or semi-finished lens blank may be finished by means of a fabrication process known as free-forming or by more traditional surfacing and polishing.

Low Add Power PAL: A Progressive Addition Lens that has less than the necessary near add power for the wearer to see clearly at a near distance.

Multifocal Lens: A lens having more than one focal point or optical power. Such lenses may be static or dynamic. Examples of static multifocal lenses include a bifocal lens, trifocal lens or a Progressive Addition Lens. Examples of dynamic multifocal lenses include electro-active lenses whereby various optical powers may be created in the lens depending on the types of electrodes used, voltages applied to the electrodes and index of refraction altered within a thin layer of liquid crystal. Multifocal lenses may also be a combination of static and dynamic. For example, an electro-active element may be used in optical communication with a static spherical lens, static single vision lens, static multifocal lens such as, by way of example only, a Progressive Addition Lens. In most, but not all, cases, multifocal lenses are refractive lenses.

Near Distance Viewing Zone: The portion of a lens containing an optical power which allows a user to see correctly at a near viewing distance.

Near Viewing Distance: The distance to which one looks, by way of example only, when reading a book, when threading a needle, or when reading instructions on a pill bottle. This distance is usually, but not always, considered to be between approximately 12 inches and approximately 16 inches from the eye. The near viewing distance may also be referred to as a near distance and a near distance point.

Office Lens/Office PAL: A specially designed Progressive Addition Lens that provides intermediate distance vision above the fitting cross, a wider channel width and also a wider reading width. This is accomplished by means of an optical design which spreads the unwanted astigmatism above the fitting cross and which replaces the far distance vision zone with that of a mostly intermediate distance vision zone. Because of these features, this type of PAL is well-suited for desk work, but one cannot drive his or her cat or use it for walking around the office or home since the lens contains no far distance viewing area.

Ophthalmic Lens: A lens suitable far vision correction which includes a spectacle lens, a contact lens, an intra-ocular lens, a corneal in-lay, and a corneal on-lay.

Optical Communication: The condition whereby two or more optics of given optical power are aligned in a manner such that light passing through the aligned optics experiences a combined optical power equal to the sum of the optical powers of the individual elements.

Patterned Electrodes: Electrodes utilized in an electro-active lens such that with the application of appropriate voltages to the electrodes, the optical power created by the liquid crystal is created diffractively regardless of the size, shape, and arrangement of the electrodes. For example, a diffractive optical effect can be dynamically produced within the liquid crystal by using concentric ring shaped electrodes.

Pixilated Electrodes: Electrodes utilized in an electro-active lens that are individually addressable regardless of the size, shape, and arrangement of the electrodes. Furthermore, because the electrodes are individually addressable, any arbitrary pattern of voltages may be applied to the electrodes. For example, pixilated electrodes may be squares or rectangles arranged in a Cartesian array or hexagons arranged in a hexagonal array. Pixilated electrodes need not be regular shapes that fit to a grid. For example, pixilated electrodes maybe concentric rings if every ring is individually addressable. Concentric pixilated electrodes can be individually addressed to create a diffractive optical effect.

Progressive Addition Region: A region of a lens having a first optical power in a first portion of the region and a second optical power in a second portion of the region wherein a continuous change in optical power exists there between. For example, a region of a lens may have a far viewing distance optical power at one end of the region. The optical power may continuously increase in, plus power across the region, to an intermediate viewing distance optical power and then to a near viewing distance optical power at the opposite end of the region. After the optical power has reached a near-viewing distance optical power, the optical power, may decrease in such a way that the optical power of this progressive addition region transitions back into the far viewing distance optical power. A progressive addition region may be on a surface of a lens or embedded within a lens. When a progressive addition region is on the surface and comprises a surface topography it is known as a progressive addition surface.

Reading Width: The narrowest horizontal width within the near distance viewing portion of the lens which provides clear, mostly distortion free correction with an optical power within 0.25 D of the wearer's near distance viewing optical power correction.

Short Channel Length: Due to aesthetic concerns or trends in eyewear fashion, it may be desirable to have a lens that is foreshortened vertically. In such a lens the channel is naturally also shorter. Short channel length refers to the length of a channel in a foreshortened PAL lens. These channel lengths are usually, but not always between approximately 11 mm and approximately 15 mm. Generally, a shorter channel length means a narrower channel width and more unwanted astigmatism. Shorter channel designs are often associated with “hard” progressives, since the transition between far distance correction and near distance correction is harder due to the steeper increase in optical power.

Soft Progressive Addition Lens: A Progressive Addition Lens with a more gradual transition between the far distance correction and the neat distance correction. In a soft PAL the unwanted distortion may be above the fitting point and spread out into the periphery of the lens. A soft PAL may also have a longer channel length and a wider channel width. A “modified soft Progressive Addition Lens” is a soft PAL which is modified to have a limited number of characteristics of a hard PAL such as a steeper optical power transition, a shorter channel, a narrower channel, more unwanted astigmatism pushed into the viewing portion of the lens, and more unwanted astigmatism below the fitting point.

Static Lens: A lens having an optical power which is not alterable with the application of electrical energy, mechanical energy or force. Examples of static lenses include spherical lenses, cylindrical lenses, Progressive Addition Lenses, bifocals, and trifocals. A static lens may also be referred to as a fixed lens. A lens may comprise a portion that is static, which may be referred to as a static power zone, segment, or region.

Unwanted Astigmatism: Unwanted aberrations, distortions or astigmatism found within a Progressive Addition Lens that are not part of the patient's prescribed vision correction, but rather are inherent in the optical design of a PAL due to the smooth gradient of optical power between the viewing zones. Although, a lens may have unwanted astigmatism across different areas of the lens of various dioptric powers, the unwanted astigmatism in the lens generally refers to the maximum unwanted astigmatism that is found in the lens. Unwanted astigmatism may also refer to the unwanted astigmatism located within a specific portion of a lens as opposed to the lens as a whole. In such a case qualifying language is used to indicate that only the unwanted astigmatism within the specific portion of the lens is being considered.

When describing dynamic lenses (e.g. dynamic power zones), the invention contemplates, by way of example only, electro-active lenses, fluid lenses, gas lenses, membrane lenses, and mechanical movable lenses, etc. Examples of such lenses can be found in Blum et al. U.S. Pat. Nos. 6,517,203, 6,491,394, 6,619,799, Epstein and Kurtin U.S. Pat. Nos. 7,008,054, 6,040,947, 5,668,620, 5,999,328, 5,956,183, 6,893,124, Silver U.S. Pat. Nos. 4,890,903, 6,069,742, 7,085,065, 6,188,525, 6,618,208, Stoner U.S. Pat. No. 5,182,585, and Quaglia U.S. Pat. No. 5,229,885. For simplicity, many of the embodiments discussed below will reference the use of electro-active lenses. However, this should not be construed as limiting in any way, as the principles described may have equal applicability to these other types of dynamic lenses.

Dynamic lenses may be used to add optical power to a portion of an optical system. However, the use of dynamic lenses may create discontinuities in optical power when the dynamic lens is in an active state. This may in-turn create “image jump” at the periphery where the optical power discontinuity exists. In contrast, PAL lenses provide a continuous change in optical power and may thereby be used minimize image jump, however, there are certain tradeoffs with using such lens designs, particularly when a strong optical add power is needed. For example, PAL lens designs create unwanted astigmatism. Moreover, the magnitude of these distortions increases at a greater than a linear rate with respect to the near distance add power. Thus, a combination of a dynamic power zone (e.g. electro-active segment), which may provide optical add power when needed, in optical communication with a progressive addition surface optic may be used to reduce some of these deficiencies. Such a combination may optimize the magnitude of image jump when the electro-active segment is turned on because the dynamic lens does not need provide the entire add power required. The combination may similarly optimize the corresponding magnitude of image distortion and swim caused by the progressive addition surface because this segment also does not need to provide the entire add optical power required. However, even systems and lenses that utilize such a combination do not necessarily remove all of the distortions, particular the image jump created by the dynamic lens when in an active state.

For example, a +2.000 D add power multifocal optic may be created by placing a +1.000 D electro-active zone in optical communication with a +1.000 D progressive addition lens design. In such a lens, the image jump perceived by the wearer will likely be less than that of a lens comprising only a +2.000 D dynamic lens. However, an image jump will still be present because of the 1.000 D discontinuity in optical power at the periphery of the dynamic power zone. The distortion and swim of such combination optics can be less than the distortion and swim that would be created by a lens that utilizes only a PAL optical component to provide the total add power (i.e. +2.000) of the lens (again distortion increases at a greater than linear rate). Thus, while it is desirable to utilize dynamic lenses, whether alone or in combination with a PAL, the use of such lenses may still create discontinuities at the periphery of the dynamic zone, which may cause undesirable properties, such as image jump.

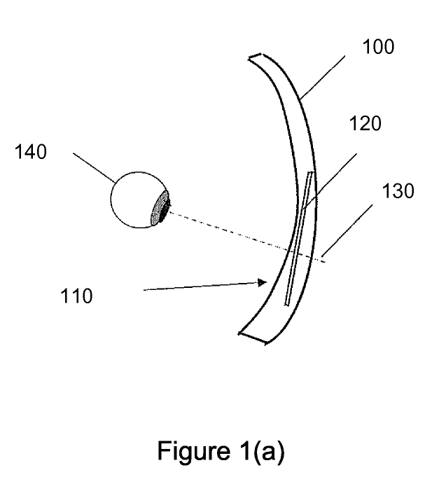

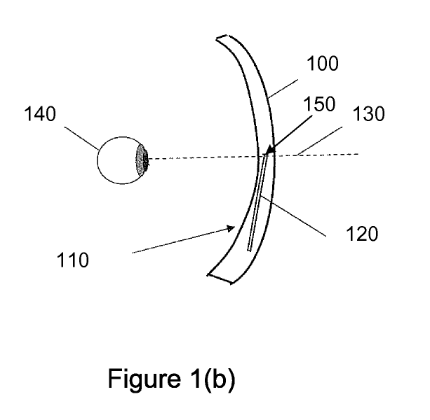

To illustrate a situation in which image jump may occur, reference will be made to FIG. 1 and the exemplary multi-focal lens 100. In some optical devices, a dynamic power zone 120 may be “turned on” (i.e. in an active state) when the wearer is reading or viewing a near object and/or adopting a downward gaze. This is illustrated in FIG. 1 (a), with light ray 130 entering pupil 140. The determination as to whether the dynamic power zone should be activated may be made in any suitable manner (such as, for instance, by a tilt switch, range finder, manual switch, etc.). As further illustrated in FIG. 1(a), the near vision zone 110 comprising the dynamic power zone 120 may cover the whole field of view. Thus, the dynamic power zone 120 may provide the correct optical power (or a portion of a total add power) to the viewer 140 when in an active state so that the viewer may observe objects that are relatively close in distance. In this exemplary embodiment, the viewer's gaze is not directed to the periphery of the dynamic power zone 120.

However, the viewer 140 may also desire to view an intermediate object by lifting the direction of gaze. This is illustrated in FIG. 1(b). In this case, the pupil 140 may scan an optical area on the dynamic power zone 120 that contains the upper boundary or periphery 150. In doing so, the eye 140 may notice a double image and an image jump as it moves across this periphery 150, in part because there is a discontinuous change in optical power across this periphery 150. This causes a discontinuous change in prism and image magnification accompanying the change in optical power.

Embodiments discussed herein provide an approach and exemplary apparatuses and systems that minimize these discontinuous changes in prism and image magnification (i.e. image jump) that occur at the boundary of the dynamic power zone (e.g. an electro active segment). It is estimated that optical power jumps of 0.500 D or less cause little perceptible change in image magnification. Embodiments provided herein may reduce the discontinuities in optical power (preferably below 0.500 D) typically created by the use of dynamic power zones by utilizing static power zones having a negative optical power at least at (e.g. in optical communication with) the periphery of the dynamic power zone. In this mariner, the discontinuity at the periphery of the combined static power zone and dynamic power zone may be reduced, and thereby reduce the effects of image jump.

It should be noted that although embodiments may be described below with reference to providing add optical power in a region of an ophthalmic device (or other optical devices) that is typically associated with a downward gaze of a viewer (e.g. a near distance viewing zone), as noted above, the systems and apparatuses disclosed herein are not so limited. Indeed, the concepts discussed herein may have a wide array of applicability to many devices that comprise discontinuities of optical power. Providing a static power zone that comprises a negative optical power at a discontinuity to, inter alia, reduce image jump may be used in any suitable application. Moreover, in some embodiments, the static power zone may provide a positive optical power at the periphery of a dynamic power zone where the dynamic power zone has a negative optical power at the periphery. A person of ordinary skill in the art would thereby recognize that this concept may be applied in many devices.

In some embodiments, a reduction in image jump can be accomplished by adding a static bifocal segment of the same size and shape as an electro-active zone in exact optical alignment with the electro-active zone. By exact optical alignment, it is meant that the alignment places the boundary (i.e. periphery) of the electro-active zone at the same location as the boundary of the static bifocal segment when viewed by a wearer, i.e., no further than 1 mm apart. In some embodiments, it is preferred that the two boundaries should be collinear to within 0.5 mm. Collinear means that the periphery of the static power zone and the dynamic power zone are in optical communication to within 0.5 mm.

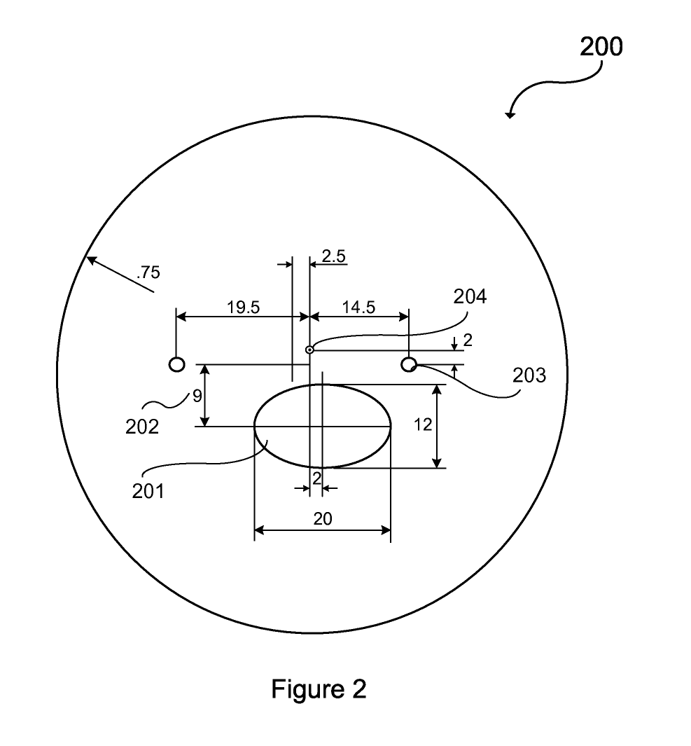

In some embodiments, the electro-active segment may be shaped to provide maximum visual comfort and visual performance while minimizing the overall size of the electro-active segment. An exemplary embodiment is shown in FIG. 2 of a multi-focal lens 200. In some embodiments, a preferred shape of the electro-active segment 201 is an ellipse because it provides a relatively wide near vision zone, while maintaining the channel length 202 to the preferred range of 9-18 mm, more preferably to 9-15 mm (as defined above, the channel length is the distance between the fitting points 203 and the location in the channel where the add power is within approximately 85%). The optical power provided by this electro-active zone 201 in this exemplary embodiment is +0.75 D. Thus, a multifocal optic 200 of +2.0 D add power may be produced by placing this +0.75 D electro-active zone in optical communication with a progressive addition lens of +1.25 D add power, as described above. In some embodiments, the onset of the add power zone of the PAL design can be coincident with the centroid of the elliptical electro-active zone 201. In this manner, the maximum add power may be provided in this region (i.e. +2.0 D).

In the exemplary multi-focal lens 200 shown in FIG. 2, there is a discontinuity of 0.75 D at the periphery of the electro-active zone 201. Thus, as provided herein, in some embodiments a static bifocal segment or zone may be provided having a negative optical power at the periphery of the electro-active zone 201. As will be described below, this static power zone can reduce the image jump created when the dynamic power zone is in an active state.

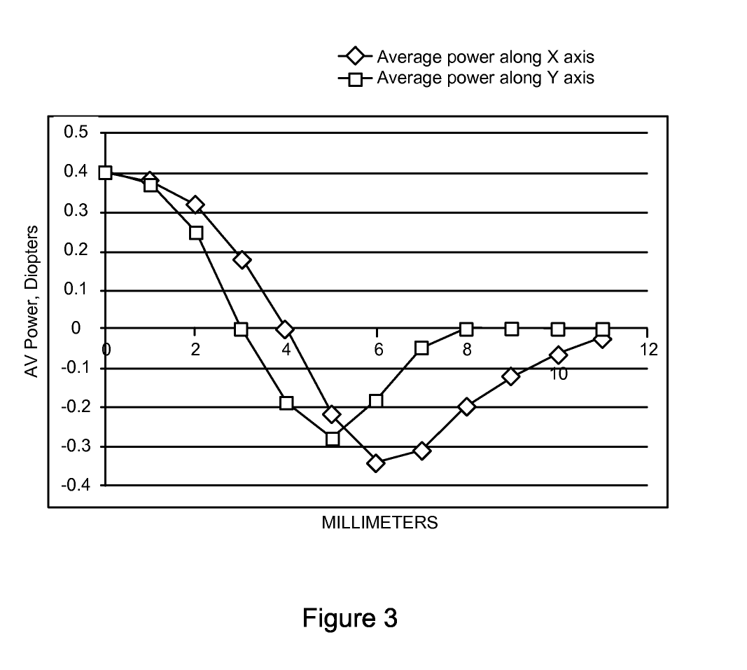

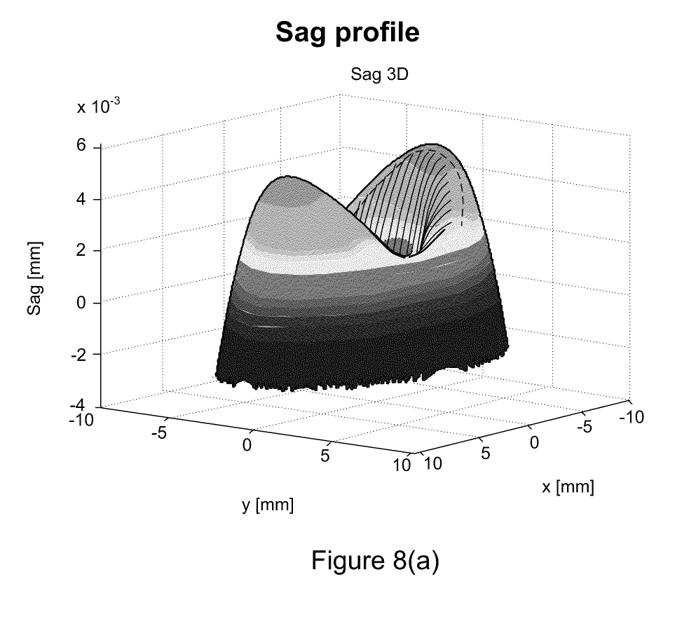

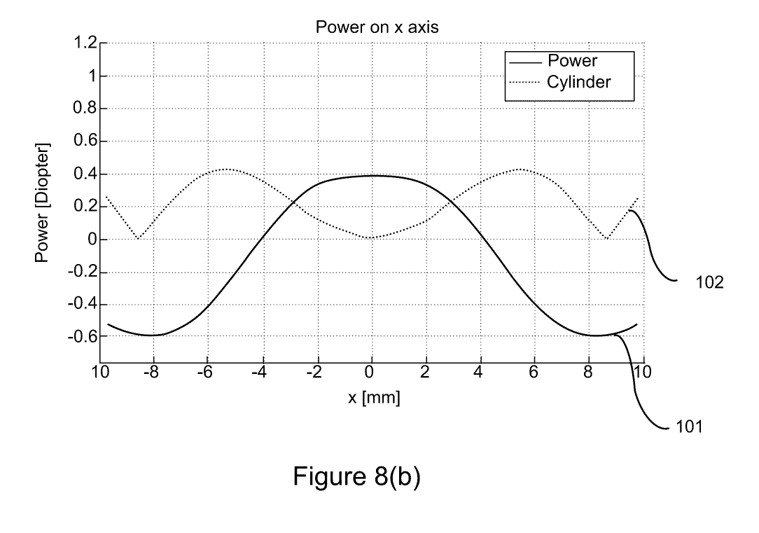

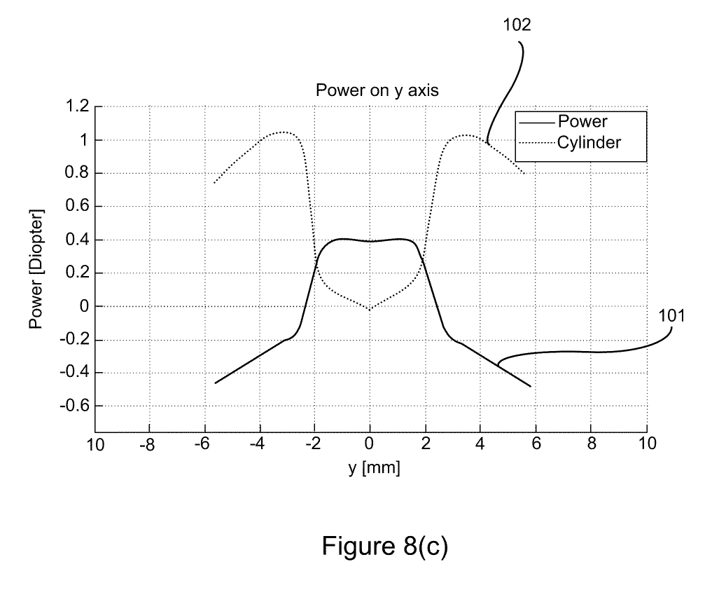

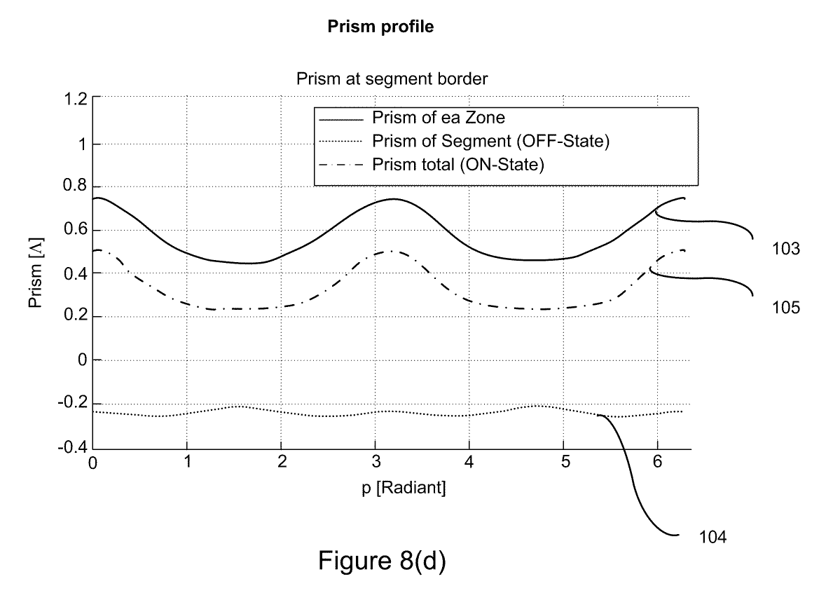

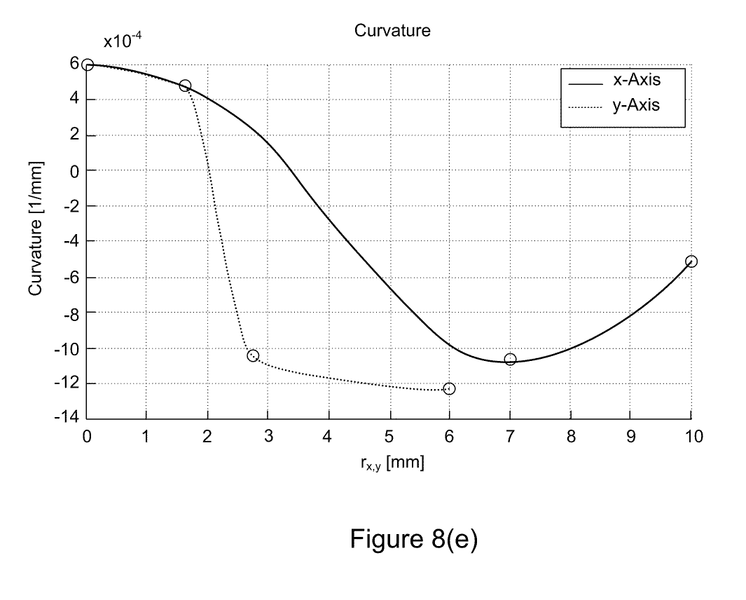

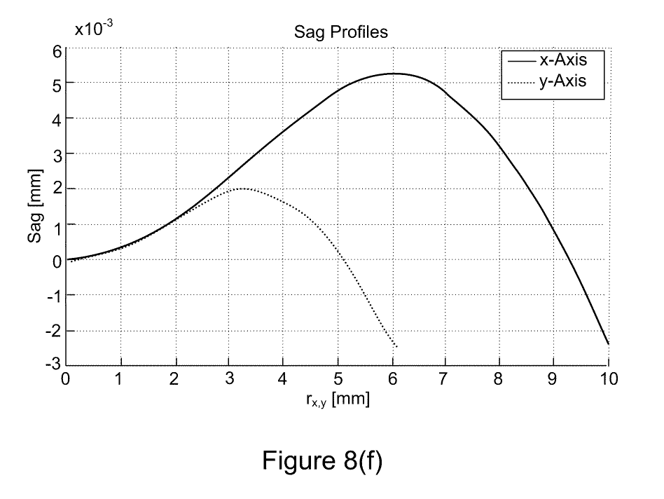

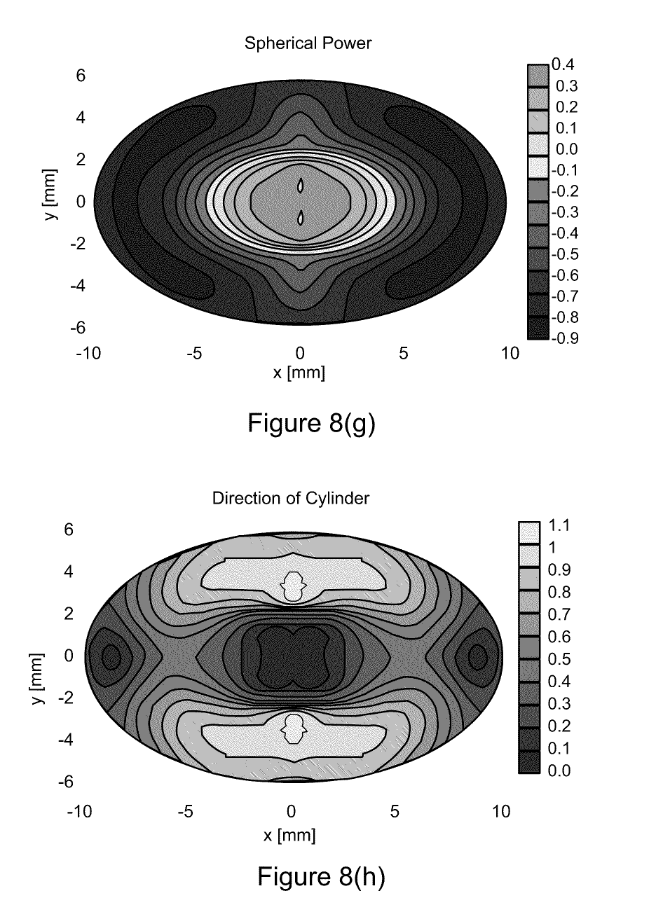

In some embodiments, the static power zone may be aspheric in geometry, with peak power at the center of the segment. Peak power means the maximum add power provided by the static power zone. Aspheric means that the shape of the static power zone is not spherical (examples of aspheric geometries are illustrated with reference to FIG. 8-11). The average optical power may drop towards the direction of the boundary (i.e. away from the center) of the static power segment or zone, and may become negative just prior to reaching the boundary, as shown in FIG. 3 (which will be discussed in detail below). The static power zone can have bilateral symmetry, such as when it is elliptically shaped. That is, two points that are located at distance on the y-axis (or congruently on the x-axis) in the plus and minus direction, respectively, from the center of the static power zone will have approximately the same optical power. In some embodiments, the static power segment or zone may be made radially symmetrical in spherical power for a round segment or zone. That is, the static power segment may have approximately the same optical power for any point at a given distance away from a central axis.

With specific reference to FIG. 3, the optical power profile of an exemplary static power zone that corresponds to the dynamic power region shown FIG. 2 is illustrated. The plot shows the optical power of the static power zone along both its x-axis (i.e. the horizontal axis in FIG. 2) labeled as “average power along the X axis” and its y-axis (i.e. the vertical direction in FIG. 2 and perpendicular to the x-axis) labeled as “average power along Y axis.” The center of the static power zone is represented at the value 0 on the x-axis, were the optical power has an optical power of 0.400 D. That is, the exemplary static power zone has an optical power of 0.400 D at the center of the electro-active zone 201.

As mentioned above, the optical power shown in FIG. 3 illustrates a static power zone that is asymptotic. Moving along the x-axis in the graph in FIG. 3 corresponds to moving away from the center of the static power zone. Thus, at 4 mm from the center of the static power zone in the x-direction (i.e. horizontally in FIG. 1), the optical power is approximately at 0.00 D (i.e. no optical power), and is in the process of transitioning from positive optical power to negative optical power. The values for the optical power profile of this exemplary static power zone are show in table 1:

TABLE 1
The average spherical power of the elliptical static segment
or zone matching the electro-active segment of FIG. 2.
Power profile of the elliptical zone, 12 × 20 mm

| | |
|---|---|
| Power along x axis | Power along y axis |

| mm | Power, D | mm | Power, D |
|---|---|---|---|
| 0 | 0.4 | 0 | 0.4 |
| 1 | 0.38 | 1 | 0.37 |
| 2 | 0.32 | 2 | 0.25 |
| 3 | 0.18 | 3 | 0 |
| 4 | 0 | 4 | −0.19 |
| 5 | −0.22 | 5 | −0.28 |
| 6 | −0.34 | 6 | −0.18 |
| 7 | −0.31 | 7 | −0.05 |
| 8 | −0.2 | | |
| 9 | −0.12 | | |
| 10 | −0.06 | | |
| 11 | −0.02 | | |

The overall peak average spherical power combining the exemplary static segment or zone (having peak of 0.400 D at its center) with the electro-active segment 201 shown in FIG. 2 (having peak optical power of 0.75 D) is +1.150 D, requiring a PAL of add power of only +0.850 D to deliver an overall add power of +2.000 D. The power jump at the boundary of the exemplary electro-active zone 201 in FIG. 2 is reduced to between 0.40 D and 0.470 D depending on the location. As noted above, it is estimated that optical power jumps of 0.500 D or less cause little perceptible change in image magnification. Thus, the exemplary embodiment utilize a dynamic power zone having an optical power discontinuity to provide add power as needed, without exhibiting as significant an image jump at the periphery of the dynamic power zone. Moreover, in the exemplary embodiment, the introduction of a static bifocal segment or zone causes the prism jump at the segment boundary to be reduced to less than 0.350 prism diopters, significantly lowering the perception of double images. This will be discussed in greater detail below with reference to FIGS. 8-11.

Furthermore, in some embodiments, the addition of a static power segment, zone, or progressive addition surface can provide a cylindrical power located so as to be optically aligned and in optical communication with the periphery of the dynamic electro-active segment. The cylindrical power at the periphery may be equal through the whole static power segment, which may be generally applicable when the segment is circular and is positioned on a spherical surface. In some embodiments, the cylindrical power of the static power zone may be variable, which may be generally applicable when the static power segment is elliptical or when it is positioned on an aspheric surface. This cylindrical power substantially reduces the astigmatism associated with the static aspheric segment such that the peak astigmatism can be less than 0.100 D. Therefore, in some embodiments, there is a net reduction of astigmatism in the resultant multifocal lens, in addition to the reduction of the image jump around the electro-active segment when turned on, because the static segment enables the applicability of a PAL design that has a lower add power and hence less maximum unwanted astigmatism.

As noted above, the examples, metrics, shapes, optical powers used herein are all examples only, and are not intended to be limiting in any way. The values chosen for the various components may depend on the intended application of the apparatus.

### Exemplary Embodiments

Additional embodiments will be described below. Embodiments of the present invention disclosed herein are directed to apparatuses and systems for reducing the image jump from a dynamic lens component. The apparatuses and systems disclosed herein may be used in ophthalmic devices, such as eye glasses or contact lenses, as well as any other suitable application.

In some embodiments, an aspheric static power zone that has a plus power at its center and minus power at its periphery is provided. The static power zone may be in optical communication with another component or components of a lens or optical system that has a plus optical power discontinuity, such as a dynamic power zone in an active state. The static power zone may reduce the total add optical power and thus the magnitude of any positive optical power discontinuity of the lens or optical system. Embodiments may have the advantage of reducing any unwanted image jump, particularly at the periphery of a dynamic power zone. Embodiments may also reduce astigmatism and/or prism effects, based in part on the negative optical power provided by the static power zone.

In some embodiments, the static power zone may be collinear with a dynamic electro-active segment having the same shape and location on an ophthalmic lens optic. By collinear, it is contemplated that the periphery of the electro-active zone and the static power zone are approximately at the same location. In some embodiments, the peripheries of each of these zones may be collinear within 1 mm. Preferably, the peripheries are collinear to within 0.5 mm.

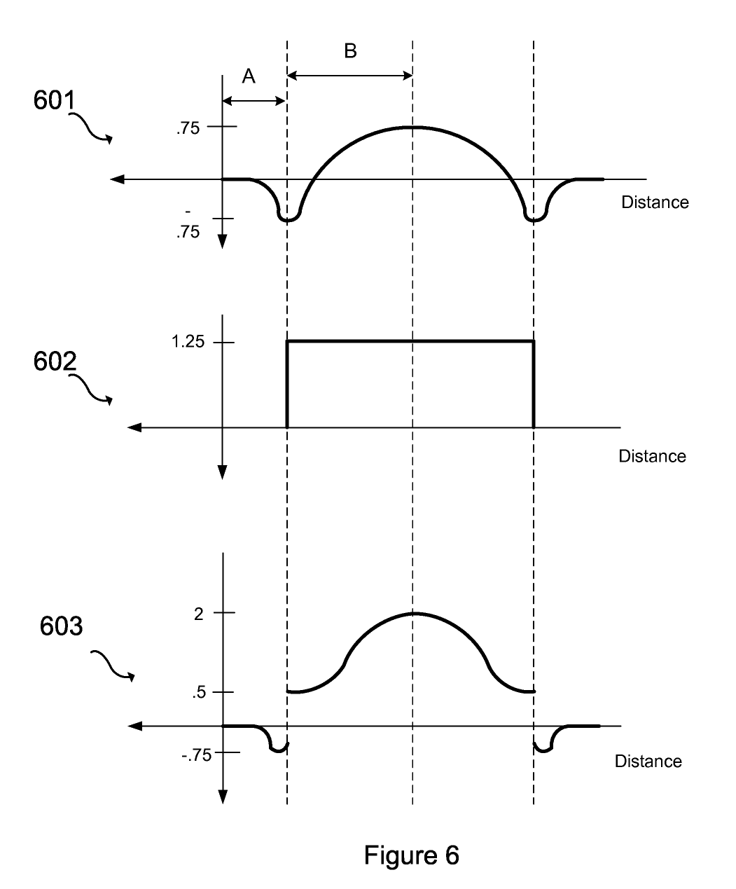

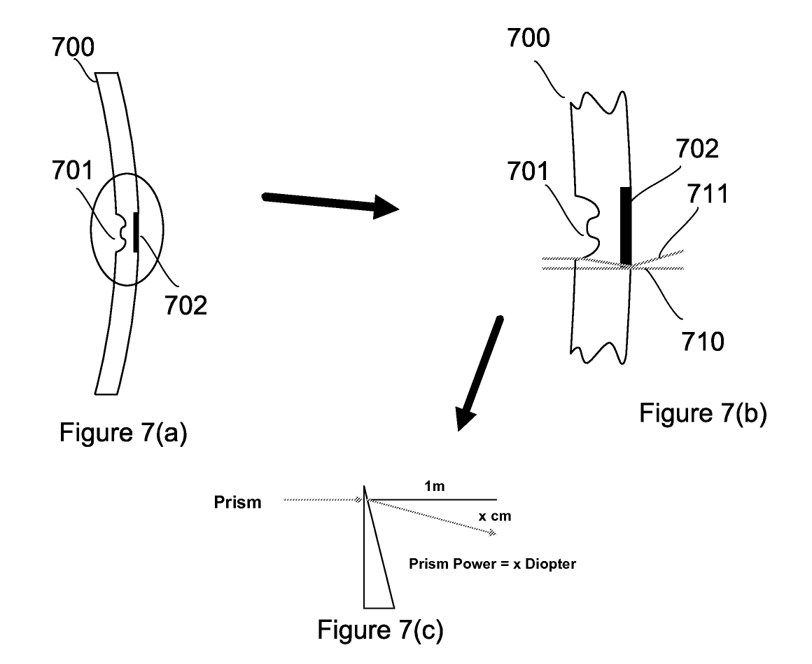

In some embodiments, the portion of the lens comprising varying optical powers (and the distortions created thereby) may be reduced by providing that the peripheries of the static power zone and the dynamic power zone are in optical communication (or approximately in optical communication)—e.g. the static power zone does not extend substantially beyond the periphery of the dynamic power zone. In addition, providing that the peripheries of the static power zone and the dynamic power zone are in optical communication may further reduce the perceived image jump at the periphery of the dynamic power zone because such embodiments may minimize the magnitude of any optical power discontinuity, particularly in embodiments where the static power zone itself provides a discontinuous optical power. For instance, assume that the static power zone provides an optical power of −0.500 D at its periphery. If this periphery is in optical communication with the periphery of a dynamic power zone providing a +0.75 D add power discontinuity, than at this location the discontinuity of the total add power will be reduced to 0.25 D. However, in some embodiments if the peripheries are not in approximate optical communication (i.e. within 1 mm or more preferably within 0.5 mm), then the perceived image jump may be on the order of the magnitude of the optical power discontinuity provided by the dynamic optical zone. This is described in more detail below with respect to FIG. 6 and FIG. 7.

In some embodiments, the maximum negative power at the periphery of the static power zone is about −1 Diopter. In some embodiments, the static power zone comprises a range of negative power at its periphery from −0.100 to −0.800.

In some embodiments, it may be advantageous for the static power zone to have the least negative optical power that still reduces the discontinuity of optical power at the periphery of the dynamic power zone (when the dynamic power zone is in an active state) to a value that is not perceivable (or is less perceivable) to a viewer (e.g. preferably less than 0.50 D). This is because when the dynamic power zone is in an inactive state, the static power zone may itself create a discontinuity in optical power. That is, in some embodiments when the dynamic power zone is not active, it may not contribute to the total add power of the lens in the region. If the static power zone has an optical power of, for instance, −0.50 D (and the static power zone provides discontinuous optical power at its periphery), then this creates a discontinuity on the order of 0.50 D. Therefore, in some embodiments, it may be beneficial to limit the magnitude of the optical power provided by the static power zone so that image jump is minimal (preferably not perceivable, at least with regard to magnification) when the dynamic power zone is in an inactive state.

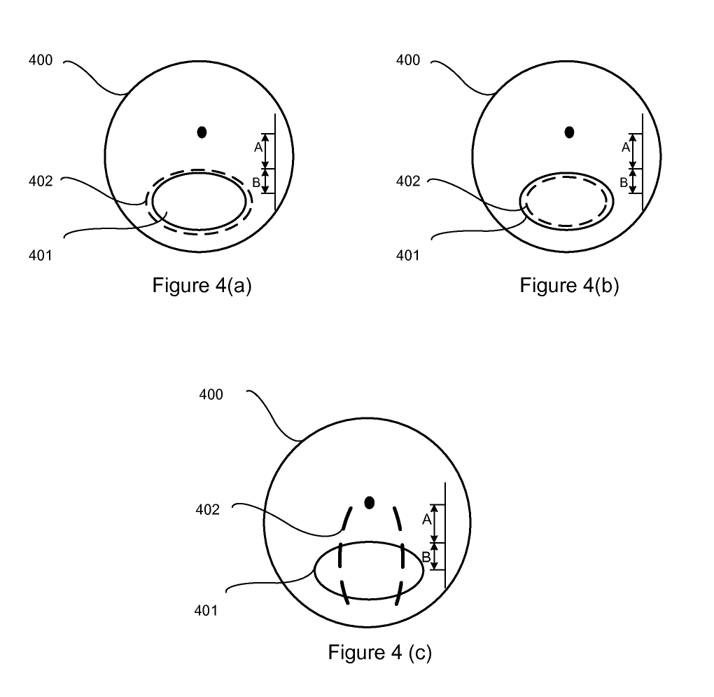

In some embodiments, the static power zone is elliptical in shape. As noted above, an ellipse may be ideal in some embodiments because it may provide a wide field of view without necessarily affecting the channel length. However, the static power zone may be any shape or size. Indeed, the ideal shape and size of the static power zone may be based on the shape and size of the dynamic power zone and/or the optical needs of the viewer. This will be discussed in more detail with reference to FIG. 4 (a)-(c) below.

In some embodiments, the static power zone provides a discontinuous change in optical power at its periphery. As discussed above, it may be preferred that the static power zone provide a discontinuous optical power in some embodiments such that the discontinuity created by a dynamic power zone when in an active state may be reduced. In this regard, it may be preferred that the peripheries of the static power zone and the dynamic power zone are in optical communication. In some embodiments, the static power zone may provide a continuous change in average spherical power and astigmatism at its periphery. An example of such an embedment was discussed with reference to FIG. 3 above. Both continuous and discontinuous embodiments will be discussed in detail with reference to FIGS. 6 and 7 below.

In some embodiments, an ophthalmic lens is provided that comprises a dynamic electro-active segment having a first add power and a static addition zone having a second add power. The static addition zone comprises a progressive addition surface that contributes a positive optical power and a minus optical power. This embodiment is illustrated in FIG. 4(c) and described in detail below. This embodiment may provide the benefit that the static power zone may provide a negative optical power at the periphery of the dynamic power zone and thereby reduce an optical power discontinuity when the dynamic power zone is in an active state. The static power zone may also provide a positive optical power to a portion of the lens that is in optical communication with the dynamic power zone at or near its center, such that the static power zone also contributes to the add power required for near vision correction. In some embodiments, the combination of the positive add powers of the static power zone and the dynamic power zone may reduce the optical power needed for an additional PAL surface, enabling a softer PAL design to be used which will have less distortion than a hard PAL. In addition, a static power zone that comprises a progressive addition surface provides the benefit that the static power zone may not itself create optical power discontinuities.

In some embodiments, a first apparatus that comprises a dynamic power zone having a periphery is provided. The periphery may comprise the outermost segments of the dynamic power zone that provide optical power when in an active state. The first apparatus further comprises a static power zone in optical communication with at least a portion of the dynamic power zone. For instance, the static power zone may be in optical communication with the entire dynamic power zone or only a segment thereof. Moreover, the static power zone has a negative optical power at a first portion of the periphery of the dynamic power zone.

As described above, typically when utilizing a dynamic power zone (such as an electro-active segment) to add optical power to a lens or other optical device, often an optical power discontinuity is created. This discontinuity can create distortions in a lens, such as image jump and astigmatism, particularly at the periphery of such a dynamic region. By providing a static power zone with a negative optical power that is in optical communication with the dynamic power zone (and in particular with at least a portion of the periphery where the optical power discontinuity exists) embodiments provided herein may reduce the image jump experienced by a viewer when gazing at objects at or near the periphery of the dynamic power zone.

In some embodiments, in the first apparatus described above, the static power zone has a positive optical power approximately at the center of the dynamic power zone. In this manner, the static power zone may contribute to the total add power required for a viewing area. In some embodiments, the add power of the static power zone may be asymmetric. Examples of such embodiments are shown in FIGS. 8-11. This asymmetry may provide the static power zone with various properties that may reduce the effect of distortion created by the dynamic power zone (or another component such as a PAL surface that is also in optical communication with the static power zone), such as the image jump and astigmatism.

In some embodiments, the static power zone has a minimum add power at a distance that is within 5 mm from the periphery of the dynamic power zone in a direction perpendicular to the periphery. That is, the static power zone may have a minimum value (i.e. negative optical power with the largest absolute value) within 5 mm of the periphery of the dynamic power zone. As noted above, in some embodiments it may be beneficial to have a large negative optical power of the static power zone close to optical communication with the dynamic power zone periphery so that the discontinuity created by the dynamic zone when activated may be reduced. In this regard, in some embodiments, the static power zone has a minimum add power at a distance that is within 1 mm from the periphery of the dynamic power zone in a direction perpendicular to the periphery.

In some embodiments, in the first apparatus as described above, the add power of a portion of the static power zone that is not in optical communication with the dynamic power zone varies continuously in a direction that is perpendicular to the periphery of the dynamic power zone until the add power reaches a value of zero Diopters. An example is illustrated in FIG. 3, where the static power zone has optical power that extends beyond the periphery of the dynamic power zone on both the x (i.e. beyond 10 mm) and y (i.e. beyond 6 mm) axes. The static power zone in such embodiments may not thereby create an optical power discontinuity when the dynamic power zone is in an inactive state. Moreover, in some instances, it may be desirable that the optical power profile of the static power zone increase exponentially at or near the periphery of the dynamic power region so that the image jump perceived by the viewer is reduced. That is, if the optical power profile varies continuously and extends beyond the periphery of the dynamic power region (i.e. there is no discontinuity at the periphery) then to reduce the perceived image jump, it may be preferred in some embodiments that the optical power is increased rapidly in a short distance at or near the periphery of the dynamic power region. In some embodiments, the add power of a portion of the static power zone that is not in optical communication with the dynamic power zone is asymptotic. For instance, the portions of the static power zone that extend beyond the periphery of the dynamic power zone may approach a value of zero, but never actually reach the value.

In some embodiments, in the first apparatus as described above, the first portion of the periphery of the dynamic power zone where the static power zone has a negative optical power comprises a portion of the periphery of the dynamic power zone between a near and a far distance viewing zone. That is, in some embodiments, the static power zone may, but need not, be in optical communication with the entire periphery of the dynamic power zone. As described above with reference to FIG. 1, the most common interface where image jump occurs is when the viewer is adjusting his gaze from the near distance viewing zone to an intermediate or far distance viewing zone. The static power zone may thereby be utilized to address this periphery of the dynamic power zone by having a negative optical power to reduce the optical power discontinuity. In some embodiments, the dynamic power zone may also be in optical communication with a portion of periphery of the dynamic power zone that is not between a near and intermediate viewing distance, but may or may not have a negative optical power at this portion of the periphery. Again, because this location between the near and intermediate distance viewing zone may be the most common location on an optical device where image jump is perceived by the viewer, embodiments may be specifically designed to reduce the distortion at this location. For instance, in some embodiments, the first portion of the periphery of the dynamic power zone where the static power zone has a negative optical power includes only a portion of the periphery of the dynamic power zone between a near and a far distance viewing zone. However, as noted above, in some embodiments, the first portion of the periphery of the dynamic power zone where the static power zone has a negative optical power comprises the entire periphery of the dynamic power zone. Such embodiments may be preferred when it is desired to address both the image jump at the periphery of the dynamic power zone, but also other distortions such as astigmatism and prism that may be created either by the dynamic power zone or other components of the apparatus (such as a PAL surface that is also in optical communication with the static power zone).

In some embodiments, in the first apparatus as described above, the dynamic power zone has a first optical power in an active state and a second optical power in an inactive state, where the second optical power is different than the first optical power. For instance, the first optical power could be no optical power (i.e. 0.00 Diopters) and the second optical power could have a positive or negative value (e.g. 1.00 D or −1.00 D). In some embodiments, the dynamic power zone comprises an electro-active segment. In some embodiments, the dynamic power zone may include a fluid lens, a mechanical lens, a membrane lens, a gas lens, and/or a combination of an electro-active segment (such as an electro-active assembly), a fluid lens, a gas lens, a membrane lens, and a mechanical lens. Indeed, embodiments described herein may address the discontinuity in optical power created by any optical component, such as any dynamic lens.

In some embodiments, in the first apparatus as described above, the static power zone is aspheric. As noted above, this simply means that the shape of the region is not spherical (examples are illustrated wither reference to FIGS. 8-11). This geometry may contribute, in part, to the asymmetric optical power profile of the static power zone. In some embodiments, the static power zone and the dynamic power zone may have a similar shape or the same shape. By “shape,” it is meant that periphery of the dynamic power zone and the periphery of the static power zone form a similar shape (i.e. the areas of each zone that are in optical communication are approximately the same). This is illustrated and described with reference to FIG. 4(a). As noted above, the shape of the static power zone may be based in part on the shape of the dynamic power zone, the requirements of the viewer, and/or whether and to what extent the distortions and image jump is to be corrected. For instance, in some embodiments if it is desirable to reduce image jump along the entire periphery of the dynamic power region, then it may be preferred to have a static power zone that has the same shape as the dynamic power zone. In some embodiments, the static power zone is elliptical in shape. In some embodiments, the static power zone and the dynamic power zone are coupled to an ophthalmic lens optic. For instance, the dynamic power zone and static power zone may form components on a lens, such as those that are included in spectacles. Moreover, the dynamic power zone and static power zone may be in optical communication with other components that are also coupled to the ophthalmic device, such as a PAL surface or other dynamic lenses.

In some embodiments, in the first apparatus as described above, the total add power of the dynamic power zone and the static power zone at the first portion of the periphery of the dynamic power zone where the static power zone has a negative optical power is less than approximately 1 Diopter when the dynamic power zone is in an active state. For instance, if the optical power of the static power zone at a portion of the periphery of the dynamic power zone is −0.50 D, and the optical power of the dynamic power region at the periphery is 0.75 D then (because the static and dynamic power zones are in optical communication at this location) the total add power would be 0.25 D (i.e. 0.75 D positive add power from the dynamic power region minus the 0.50 D negative add power from the static power region). Preferably, the total add power of the dynamic power zone and the static power zone at the first portion of the periphery is less than approximately 0.5 Diopters when the dynamic power zone is in an active state. As noted above, it is believed that most viewers do not perceive changes in image magnification when the discontinuity is less than about 0.50 D, and the perception of prism jump may also be reduced.

In some embodiments, in the first apparatus as described above the dynamic power zone, when in an active state, has an optical power at the first portion of its periphery (where the static power zone has a negative optical power) that is greater than approximately 0.5 Diopters. That is, the dynamic power zone at the portion of the periphery that is in optical communication with a portion of the static progressive zone having a negative optical power has an optical power of 0.5 Diopters or greater. Similarly, in some embodiments, the dynamic power zone, when in an active state, has an optical power at the first portion of its periphery that is greater than approximately 1 Diopter and/or 1.5 Diopters. The amount of optical power provided by the dynamic power zone may depend on the optical power required by the viewer and/or other optical components of the apparatus (such as any PAL surfaces). Moreover, as noted above, the severity of the image jump that may be perceived by a viewer when crossing a portion of the optical device that has an optical power discontinuity is based in part on the magnitude of the discontinuity. It may therefore be preferable in some embodiments to increase the magnitude of the negative optical power of the static power zone as the optical power of the dynamic power zone is increased, such that the optical power discontinuity of the dynamic power zone is maintained at levels that reduce or eliminate the perceptibility of an image jump. However, in so doing, in some embodiments, the optical discontinuity of the static power zone when the dynamic power zone is in an inactive state may also need to be considered, and may be a limiting factor.

In some embodiments, in the first apparatus as described above, the static power zone has a minimum optical power at the first portion of the periphery of the dynamic power zone (where the static power zone has a negative optical power) of approximately −1 Diopter. By “minimum,” what is meant is that the static power zone has its most negative optical power. In some embodiments, the static power zone has an optical power at the first portion of the periphery of the dynamic power zone approximately within the range of −0.1 to −0.8 Diopters. For instance, the optical power of the static power zone along the portion of the dynamic power region may vary based on, for example, the location (i.e. whether a portion between a near and intermediate distance viewing area, how far from the viewing area this portion is, etc.). As noted above, the static power zone in some embodiments may create a discontinuity in optical power when the dynamic power zone is in an inactive zone, and thereby having a range of optical powers that is below −0.8 may maintain acceptable levels of image jump for a viewer when the dynamic optic zone is not active.

In some embodiments, the static power zone may be radially symmetrical in spherical optical power. That is, the optical power of the static power zone at a distance from a central axis (in some embodiments, this may be the center of the dynamic power region) will be approximately the same, regardless of the direction. In some embodiments, the static power zone is bilaterally symmetrical in spherical optical power. That is, two points that are located at distance on the y-axis (or congruently on the x-axis) in the plus and minus direction, respectively, from the center of the static power zone will have approximately the same optical power.

In some embodiments, in the first apparatus as described above, the static power zone provides a discontinuous change in optical power at the first portion of the periphery of the dynamic power zone where the static power region has a negative optical power. As discussed above, it may be preferred in some embodiments that the static power zone provide a discontinuous optical power such that the discontinuity created by a dynamic power zone when in an active state may be reduced. In this regard, it may be preferred in some embodiments that the peripheries of the static power zone and the dynamic power zone are in optical communication. In some embodiments, the static power zone provides a continuous change in average spherical optical power and/or astigmatism at the first portion of the periphery of the dynamic power zone. An example of such an embedment was discussed with reference to FIG. 3 above. Both continuous and discontinuous embodiments will be discussed in more detail with reference to FIGS. 6 and 7 below. In some embodiments, the static power zone comprises a progressive addition surface. The static progressive zone may have an optical power that increases from a negative value to a positive value. The negative value may be located at the first portion the dynamic power zone.

In some embodiments, in the first apparatus as described above, the static power zone has a change from positive optical power to negative optical power at a perpendicular distance from the periphery of the dynamic power zone approximately within the range of 2 to 6 mm. That is, the static power zone may have a negative power at the periphery of the dynamic power zone (e.g. to reduce the discontinuity when the dynamic power zone is in an active state) and transition to a positive optical power at a perpendicular distance within the above range. This may enable the static power zone to both reduce the discontinuity at the periphery of the dynamic power zone, and also contribute to the total add power of the near distance viewing zone. Furthermore, by transitioning within 2-6 mm, it may be possible to reduce the size of dynamic and static power regions. In some embodiments, the static power zone has a change from positive optical power to negative optical power at a perpendicular distance from the center of the dynamic power zone approximately within the range of 2-5 mm. In some embodiments, the optical power at the center of the static power zone is approximately within the range of 0.3 to 0.5 Diopters. By providing a positive optical power at the center of the static power zone, the static power zone may both reduce continuities at the periphery of the dynamic power zone (based in part on the negative optical power located there), and also contribute to the optical power required for near distance viewing as required (based in part on the positive optical power).

In some embodiments, in the first apparatus as described above, the static power zone has a prism power at the first portion of the periphery of the dynamic power zone (where the static power zone has a negative optical power) approximately within the range of 0 to −0.3 prism Diopters. It should be noted that prism, like lens power, is also measured in Diopters, but this measure is different. One Diopter of “Prism” (i.e. “prism Diopters”) is equal to the prism required to divert a ray of light 1 cm from its original path, measured at a distance of 1 m from the prism. This is illustrated in FIG. 7(c). Another component of prism besides the power is the direction of prism (i.e. the direction that an image is displaced). Prism direction can be specified in two ways, either using the prescriber's method or the 360 method. The prism power of three exemplary embodiments is shown in FIGS. 8-11(d), which will be discussed below. In some embodiments, the static power zone has a prism power at the first portion of the periphery of the dynamic power zone approximately within the range of −0.05 to −0.25 prism Diopters. A prism Diopter of less than 0.25 is typically difficult for a viewer to perceive, and therefore when the dynamic power zone is not active, the prism created by the static power zone may be within an acceptable range of values.

In some embodiments, the total prism power of the dynamic power zone and the static power zone at the first portion of the periphery of the dynamic power zone when the dynamic power zone is in an active state is approximately within the range of 0.1 to 1.0 prism Diopters. As illustrated in FIG. 7(b), the discontinuity in the optical power at the periphery of the dynamic zone results in prism power—i.e. double image (a component of image jump). However, the negative optical power provided by the static power zone may offset and/or correct some of the prism jump caused by the periphery of the dynamic power zone. In some embodiments, the total prism power of the dynamic power zone and the static power zone at the first portion of the periphery of the dynamic power zone when the dynamic power zone is in an active state is approximately within the range of 0.3 to 0.8 prism Diopters.

In some embodiments, in the first apparatus described above, the total prism power from the dynamic power zone and the static power zone at the first portion of the periphery of the dynamic power zone where the static power zone has a negative optical power, when the dynamic power zone is in an active state, is less than approximately 0.5 Diopters. Preferably, the total prism power is less than approximately 0.35 Diopters. As noted above, the lower the prism power the less perceptible the prism jump may be to a viewer, and a value that is less than 0.5 prism Diopters may be acceptable to a viewer in some embodiments.

In some embodiments, in the first apparatus as described above, the maximum total add power of the static zone and the dynamic power zone when the dynamic power zone is in an active state is at least 1 Diopter. In some embodiments, the total add power is at least 1.5 Diopters. As was described above, in some embodiments, the static power zone may provide both negative optical power to reduce the effects of image jump at the periphery of the dynamic zone, and also provide positive optical power within the periphery of the dynamic power zone as a component of a total add power required for, e.g., correction of a near distance viewing zone. If the total add power of 1.5 Diopters was provided by the dynamic power zone alone, the image jump at the periphery (having a discontinuity of 1.5) would like be perceivable to the viewer.

Exemplary embodiments of the static power zone are provided in FIG. 8-11, which demonstrate values for, inter alia, the radius of curvature of the static power zone and the sag values. It should be noted that sag is a way in which to describe non-spherical (aspheric) profiles such as the surfaces of aspheric lenses. It is defined as the he z-component of the displacement of the surface from the vertex, at distance from the axis. In the exemplary embodiments shown in FIGS. 8-11, the vertex is the point at the origin (i.e. at the center of the dynamic power zone). These are described in more detail below in the discussion of the figures, but it should be noted that the discussion is for illustration purposes only, and is not limiting.

The radius of curvature is a component in determining the optical power of the static power zone. Thus, depending on the optical power desired (not only at the periphery of the dynamic power zone but also at locations in optical communications with other portions of the dynamic power zone), the radius curvature may vary across the static power zone. In some embodiments, in the first apparatus as described above, the static power zone has a maximum radius of curvature that is less than approximately 6×10⁻⁴ mm⁻¹. The static power zone may have a maximum radius of curvature that is less than approximately 4×10⁻⁴ mm⁻¹. In some embodiments, the static power zone has a minimum radius of curvature that is greater than approximately −13×10⁻⁴ mm⁻¹. In some embodiments, the static power zone may have a minimum radius of curvature that is greater than approximately −10×10⁻⁴ mm⁻¹ and a maximum radius of curvature that is less than approximately 5×10⁻⁴ mm⁻¹. The values provided, however, are for exemplary purposes only, and may include any acceptable value based on the amount of optical power needed, the size of the dynamic power region, and factors such as the lens material and other components of the lens system that may contribute to the optical power. In some embodiments, it may be preferable to minimize the radius of curvature in some embodiments to reduce the overall size of the static power zone in the z-direction.

In some embodiments, in the first apparatus as described above, the static power zone has a minimum sag that is greater than approximately −6×10⁻³ mm and a maximum sag that is less than approximately 6×10⁻³ mm⁻¹. As noted above, the sag indicates the displacement in the z axis (i.e. direction that is perpendicular to the x (horizontal axis in FIG. 2) and y axis (vertical direction in FIG. 3)). The vertex in the exemplary embodiments is the vertical position at the center of the static power zone. In some embodiments, the static power zone has a minimum sag greater than approximately −3×10⁻³ mm and a maximum sag that is less than approximately 3×10⁻³ mm⁻¹. In some embodiments, it may be preferable to minimize the sag of static power zone in some embodiments to reduce the overall size of the static power zone in the z-direction.

In some embodiments, a first ophthalmic lens is provided that comprises a dynamic electro-active segment having a first add optical power and a static addition zone having a second add optical power. The static addition zone comprises a progressive addition surface that contributes a positive optical power and a minus optical power. These embodiments permit a continuous change in optical power for the static power zone, which may prevent an image jump from occurring when the dynamic power zone is in an inactive state. The static addition zone may have at least a first portion in optical communication with at least a portion of the periphery of the dynamic electro-active segment. The first portion of the static addition zone may have a negative optical power. Because of the negative optical power, the static power zone may contribute to the add power along a portion of the periphery of the lens to reduce the optical power discontinuity and thereby reduce the image jump perceived by the user.

In some embodiments, in the first ophthalmic lens as described above, the total add optical power of the first portion of the static addition zone and the portion of the periphery of the dynamic electro-active segment, when the dynamic electro-active segment is activated, is less than 1.0 Diopter. Preferably, the total add optical power is less than 0.5 Diopters. As noted above a difference of less than 0.5 Diopters in optical power results in image magnification that may be difficult to perceive by a viewer. In some embodiments, the static addition zone and the dynamic electro-active segment have a similar shape and are located in approximately the same location on the ophthalmic lens.

It should be understood that the features described above may be combined in any suitable manner consistent with the embodiments disclosed above. For instance, some embodiments may utilize a static power zone that has an optical power between −0.10 D to −1.5 D in optical communication with the periphery of the dynamic power zone, where the optical power zone has an optical power between 0.50 D and 2.0 D. However, any suitable combination may be used. Moreover, when utilizing any suitable combination of optical powers, the static and dynamic power zones may have any suitable shape, including elliptical. Thus, the specific embodiments discussed above are for illustration purposes only and should not be considered limiting. CL DESCRIPTION OF THE FIGURES

FIGS. 4-7 will now be described in more detail. The figures represent exemplary embodiments and are for illustration purposes only. The figures are not meant to be limiting. It should be noted that the figures are not drawn to scale.

FIG. 4(a)-(c) illustrate three exemplary multi-focal lenses. The multifocal lenses comprise a dynamic power region 401 and a static power region 402. FIGS. 4(a) and (b) show an embodiment whereby the shapes of the dynamic 401 and static 402 power zones are similar. As illustrated in FIG. 4(a), the static power zone 402 is slightly larger than the dynamic power region 401. However, as noted above, the dynamic 401 and static 402 power zones may be any shape, and in some embodiments may be the same shape and/or be collinear. That is, each of the dynamic 401 and static 402 zones could be located on the same potion of lens 400 and have the same shape and size. FIG. 4(b) illustrates an embodiment whereby the static power zone 402 may be slightly smaller in size than the dynamic power zone 401. In some embodiments, the static power zone 401 and dynamic power zone 402 may be different sizes but the peripheries of each may be optical communication because of refraction caused by the optical power provided by the dynamic power zone (or the static power zone). The intercept between “A” and “B” is the y-coordinate of the periphery of the dynamic power zone on the y-axis. As noted above, in some embodiments, the shape and location of the dynamic power zone 402 and static power zone 401 are such that the peripheries of each (or a portion thereof) are in optical communication.

FIG. 4(c) shows another embodiment of lens 400 in which the static power zone 402 comprises a progressive addition surface design. As illustrated, the static power zone 402 extends beyond the periphery of the dynamic power zone 401. Moreover, in this exemplary embodiment, the static power zone 402 is not in optical communication with the entire periphery of the dynamic power zone. Thus, as illustrated, there may be a reduction in optical power discontinuity on the portion of the periphery of the dynamic power zone 401 between the intermediate and near vision viewing distance zones, but such discontinuity may still be present at other locations on the periphery. In some embodiments, the static power zone 402, when comprising a progressive surface, may have a periphery that is located in optical communication with the periphery of the dynamic power zone 401 (or within 1 mm).

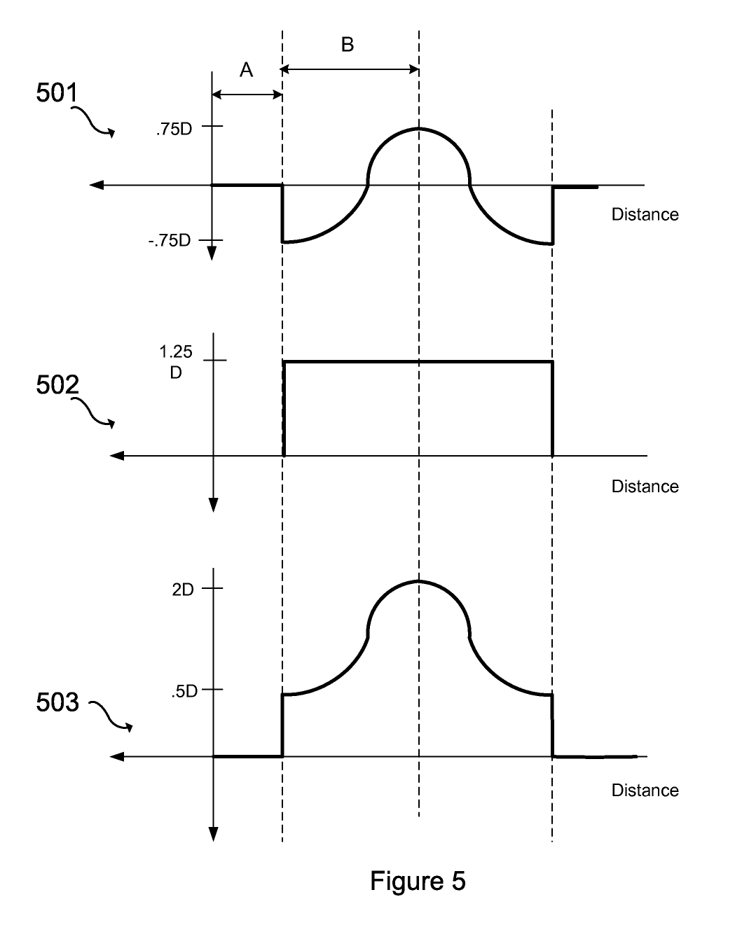

FIGS. 5 and 6 disclose a series of plots that show the relationship between the optical power of the static power zone, the dynamic power zone, and the total add power of the static power zone and the dynamic power zone (assuming that they are in optical communication) for an exemplary embodiment. The plots, the values disclosed therein such as the optical power profile of the static power zone, and the positional relation between the static power zone and dynamic power zone are disclosed for illustration purposes only.

With reference to FIG. 5, a plot of the optical power vs. distance from the center of a multifocal lens of the static power zone 501, the dynamic power zone 502, and the total add power of the static and dynamic power zone 503 are shown. The distance “A” shown as a vertical dotted line through the three plots represents the distance from the center of a multi-focal lens to the periphery of the dynamic power zone 502. The distance “B” shown as a vertical dotted line through the three plots represents the distance from the periphery of the dynamic power zone 502 to the center of the dynamic power zone 502. In this exemplary embodiment, the static power zone 501 is depicted as having a maximum optical power of 0.75 D and a minimum optical power of −0.75 D and the dynamic power zone 502 is depicted as having an optical power of 1.25 D. Moreover, the static power zone 501 in this embodiment has its periphery located in optical communication with the periphery of the dynamic power zone 502, and also has a discontinuity at its periphery (i.e. of 0.75 D). Furthermore, the optical power profile of the static power zone 501 is asymmetric. It should be noted again that FIG. 5 is for illustrative purposes only. For instance in some embodiments, the power profiles of either the static 501 or dynamic 502 power zones may not be symmetric around the center of the dynamic power zone 502.

As shown in the exemplary embodiment of FIG. 5, at the periphery of the static 501 and dynamic 502 power zones at a distance A (i.e. at the periphery of the dynamic power zone), each zone has an optical power discontinuity. The static power zone 501 has an optical power of −0.75 D and the dynamic power zone 502 (assuming it is in an active state) has an optical power of 1.25 D. Assuming that the peripheries are in optical communication, the total add power is equal to 0.50 D (1.25 D-0.75 D). This is shown in the total add power profile 503. Thus, when taken alone the static power zone 501 and dynamic power zone 502 each have an optical power discontinuity of 0.75 and 1.25, respectively; however, when taken together, the discontinuity is actually less (0.50 D), and thus the image jump perceived by a user at the periphery will also be likely be less. As shown in FIG. 5, the dynamic power zone 502 has a constant optical power, and thus the total add power 503 tracks the optical power increases and decreases of the static power zone 503.

With reference to FIG. 6, a plot of the optical power vs. distance from the center of an exemplary multifocal lens of the static power zone 601, the dynamic power zone 602, and the total add power of the static and dynamic power zone 603 are shown. The distance “A” shown as a vertical dotted line through the three plots represents the distance from the center of a multi-focal lens to the periphery of the dynamic power zone 502. The distance “B” shown as a vertical dotted line through the three plots represents the distance from the periphery of the dynamic power zone 602 to the center of the dynamic power zone 602. In this exemplary embodiment, the static power zone 601 is depicted as having a maximum optical power of 0.75 D and a minimum optical power of −0.75 D and the dynamic power zone 602 is depicted as having an optical power of 1.25 D. Moreover, the static power zone 601 in this embodiment has its periphery located a distance away from optical communication with the periphery of the dynamic power zone 502. Moreover, the static power zone has a continuous optical power profile (i.e. it does not have discontinuity at its periphery). Furthermore, the optical power profile of the static power zone 601 is asymmetric. It should be noted again FIG. 6 is for illustrative purposes only. For instance in some embodiments, the power profiles of either the static 601 or dynamic 602 power zones may not be symmetric around the center of the dynamic power zone 602.

As shown in this exemplary embodiment of FIG. 6, the total add power 603 of the multi-focal lens initially tracks the value of the static power zone 601 for the distance “A” until the periphery of the dynamic power zone 602 is reached. At this point (assuming the dynamic power zone 602 is in an active state), there is a discontinuity that is created at the periphery of the total add optical power 603. Although the value of the optical power of the multifocal lens is equal to the total add power of the static 601 and dynamic 602 power zones (i.e. 1.25 D−0.75 D=0.50 D), the discontinuity in optical power may actually be greater because the static power zone 601 (and therefore the total add power 603) was initially negative (i.e. non-zero) prior to the reaching the periphery of the dynamic power zone 602. Thus, assuming that the optical power of the static power zone prior to the periphery of the dynamic power zone was approximately −0.75, the discontinuity in optical power may be (0.50 D−(−0.75 D)=1.25 D), the value of the optical power of the dynamic power lens. Thus, this illustrates that it may preferable in some embodiments to have the periphery of the static and dynamic optical power zones in optical communication. However, in some embodiments, the discontinuity may be continuous but also increase exponentially in close proximity to the periphery of the dynamic power zone. The closer and steeper the increase in negative optical power provided by the static power zone is (i.e. as the static power zone approaches a discontinuity at the periphery of the dynamic power zone), the less perceptible the difference between the negative optical power provided by the static power zone prior to the periphery of the dynamic power zone is to a viewer.

In some embodiments, even if the peripheries of the static 601 and dynamic 602 power zones are not exactly in optical communication, but are within, for example, 1 mm, the image jump may not be perceived (or be less perceptible) by the viewer.

Simulations of Exemplary Embodiments

FIGS. 7-11 disclose exemplary multi-focal lenses in accordance with some embodiments discussed herein. Each of these exemplary embodiments is disclosed for illustrative purposes, and should not be construed as limiting in any way. The results provided herein are simulation results utilizing a particular exemplary static power zone like that shown as 701.

FIGS. 7(a) and (b) show a side view of a portion of a multi-focal lens 700. The exemplary lens 700 comprises an dynamic power zone 702 and a static power zone 701. The static power zone 701 is shown as having a periphery in optical communication with the dynamic power zone for illustration purposes only. As noted above, optical communication is defined as light passing through the aligned optics experiences a combined optical power equal to the sum of the optical powers of the individual elements. As disclosed above, however, embodiments are not so limited.

FIG. 7(b) shows an enlarged segment of the exemplary lens 700. As shown, at the periphery of the dynamic power zone 702, there is prism effect caused by the discontinuity in optical power. Light ray 710 passes un-refracted just outside the periphery of the dynamic power zone 702, where as light ray 711 enters the dynamic power zone 702 at the periphery and is refracted. Prior to entering the static power zone 701, a viewer would perceive the image as being displaced. However, the exemplary static power zone 701, comprising a negative optical power in optical communication with the periphery of the dynamic power zone 702, may refract the light ray 711 and eliminate or reduce the perceived prism jump. In this way, embodiments provide a static power zone 701 that has a negative optical power, which may thereby reduce the effects of the discontinuity in optical power created by the dynamic power zone 702 may be mitigated. FIG. 7(c) was discussed above, and illustrates the calculation of prism power. It should be noted that although the dynamic power zone 702 is depicted in front of the static power zone 701 (i.e. light passes through the dynamic power zone prior to passing through the static power zone 701 and then to the viewer's eye), embodiments are not so limited. The static power zone 701 may be located on the front of the lens 700, or in any suitable location in relation to the dynamic power zone 702.

FIGS. 8-11 disclose four exemplary embodiments of multi-focal lenses and static power zones, as well as simulated results showing the characteristics thereof. It should be noted that these embodiments are illustrative, and that many values for each of the characteristics disclosed herein may be used. In particular, the inventors have evaluated power profiles for the static power zone 701 that have bilateral symmetry, (e.g., the power profiles can be independently altered along x and y axes). Four such exemplary profiles are provided herein. Of note is that each of the exemplary profiles provides a particular reduction in prism jump that causes image jump, while introducing additional astigmatism into the optic. The examples demonstrate that it is possible to alter the power profiles along x axis relative to the y axis in order to maximize the efficacy of image jump reduction effect along specific areas of the optic The optimization process may also involve minimization of astigmatism introduced by the static power zone. The results are discussed below.

With reference to FIGS. 8-11 (a), disclosed are 3-d plots of the sag profile of the exemplary embodiments. This illustrates the displacement of the surface of the static power zone 701 in the z-direction, as discussed above. FIGS. 8-11 (b) and (c) illustrate the optical power profiles for both spherical and cylindrical optical power for the exemplary static power zones shown in FIGS. 8-11(a), respectively. In particular, the plot 101 shows the spherical power and the plot 102 shows the cylindrical power of the exemplary embodiments in FIGS. 8-11 as a function of the distance from the center of the dynamic power zone 702. FIGS. 8-11(d) illustrate the prism jump at periphery of the static power zone 701. Each of these figures includes the plots of the prism power for the dynamic power zone 103, the static power zone 104, and the total prism of the static 701 and dynamic 702 power zones 105. It should be noted that in each of these exemplary embodiments, the total prism 105 is less than the prism that is created by the dynamic power zone 103 because the static power zone 104 has a negative prism at the periphery.

FIGS. 8-11(e) show plots of the curvature of the exemplary static power zones 701 along both the x axis (solid line) and the y axis (dotted line). In these exemplary embodiments, the static power zones 701 are bilaterally symmetric. FIGS. 8-11(f) discloses the sag profiles in 2-d plots (which correspond to FIGS. 8-11(a)) along both the x (solid line) and y (dotted line) axes of the exemplary static power zones 701. Finally, FIGS. 8-11(g) and (h) are 3-d contour plots of the spherical power and the direction of the cylindrical power for the exemplary embodiments of the static power zones 701.

A summary of some of the properties of each of the exemplary static power zones is as follows:

For the exemplary embodiment disclosed in FIGS. 8(a)-(h):

| | |
|---|---|
| Prism of Segment on x-Axis = −0.2381 | on y-Axis = −0.2116 |
| Power at Center = 0.3894 | |
| Cylinder at Center = 0.0040 | |
| Power at border on x-Axis = −0.5388 | on y-Axis = −0.4680 |

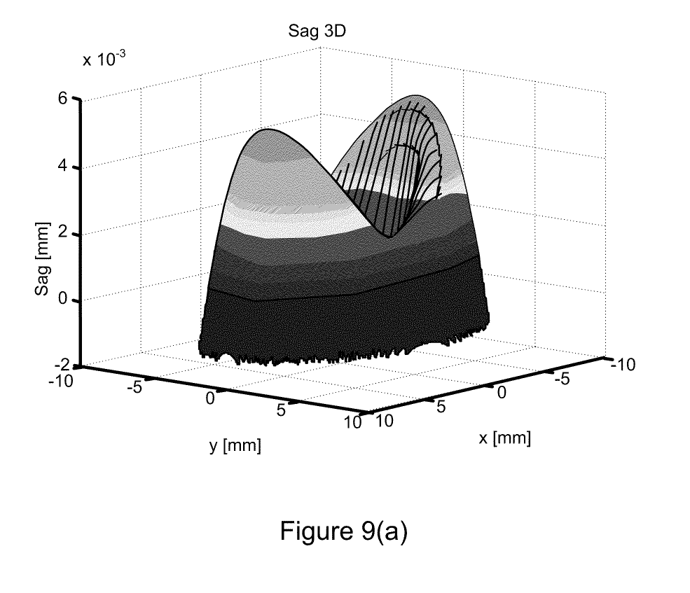

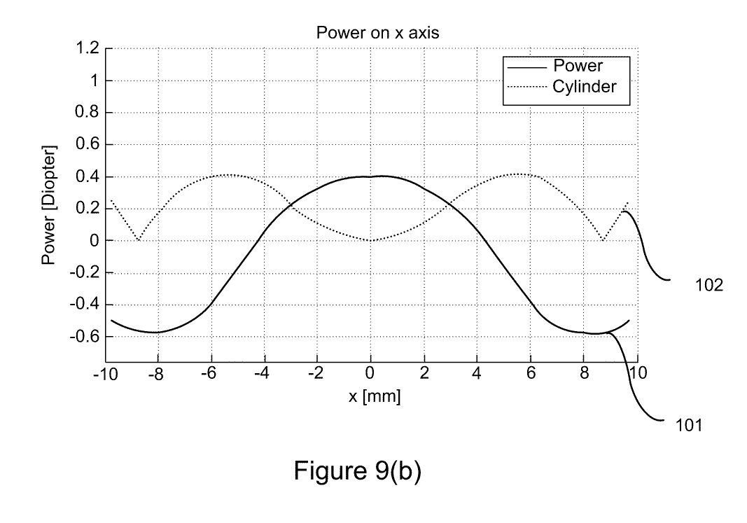

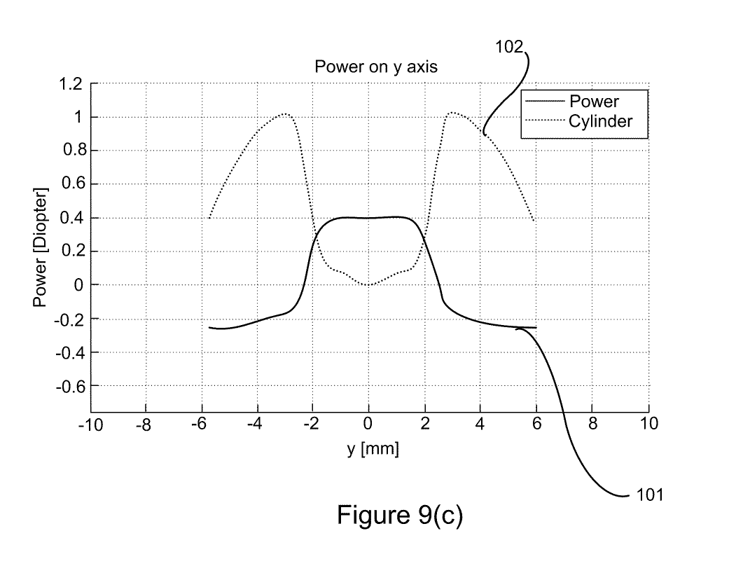

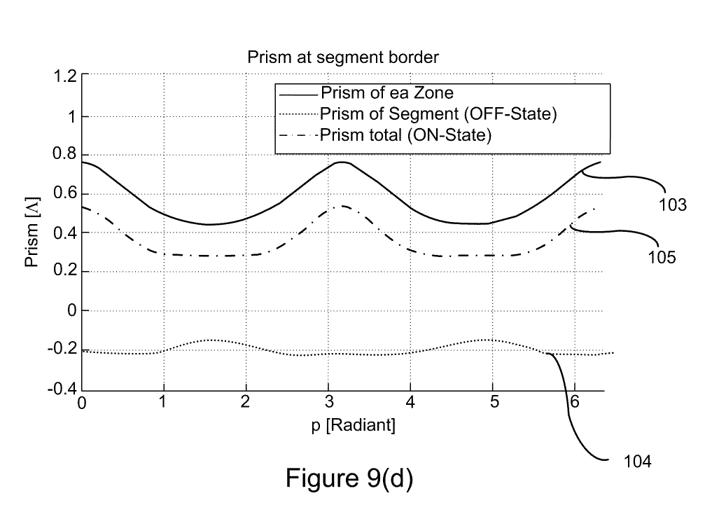

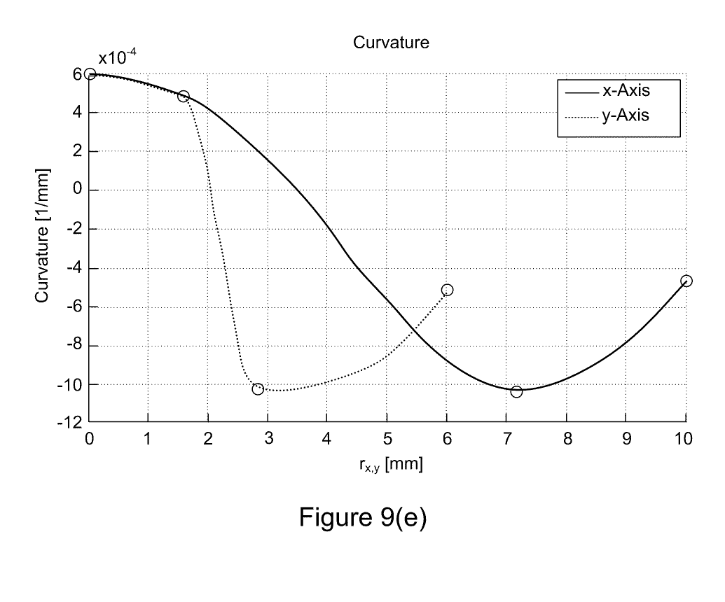

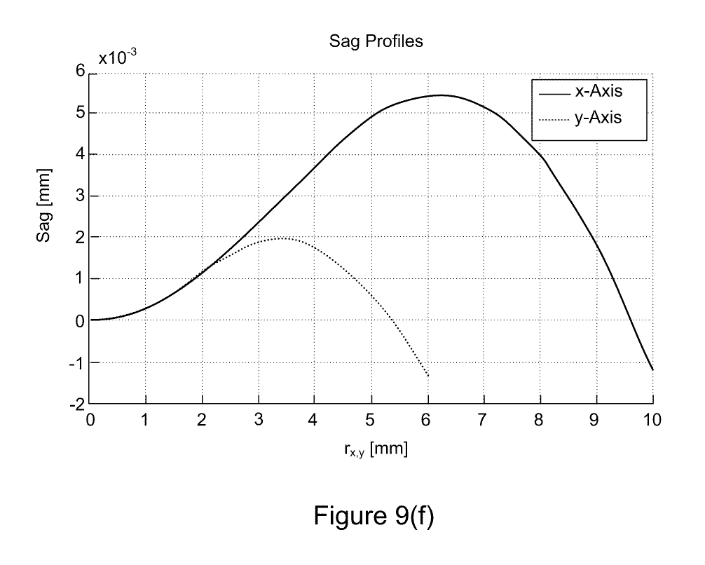

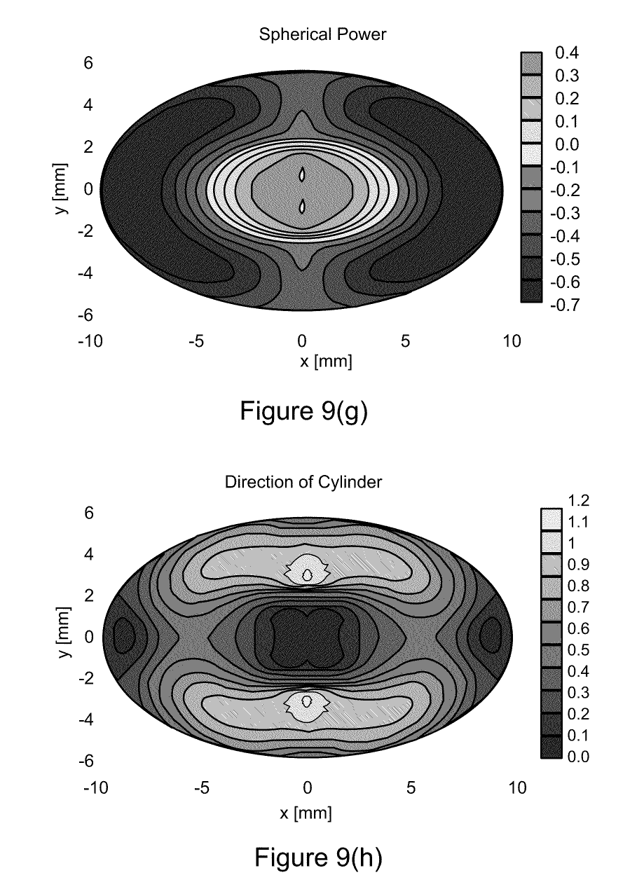

For the exemplary embodiment disclosed in FIGS. 9(a)-(h):

| | |
|---|---|
| Prism of Segment on x-Axis = −0.2170 | on y-Axis = −0.1495 |
| Power at Center = 0.3894 | |
| Cylinder at Center = 0.0040 | |
| Power at border on x-Axis = −0.4891 | on y-Axis = −0.2398 |

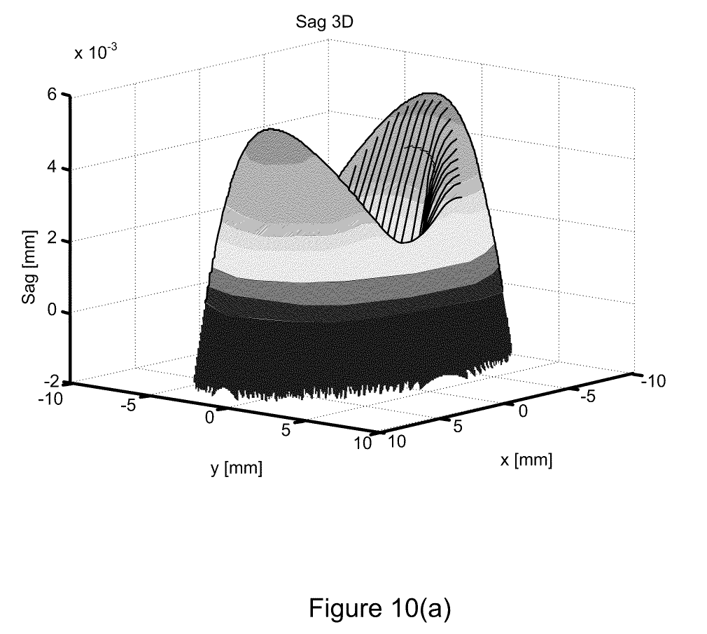

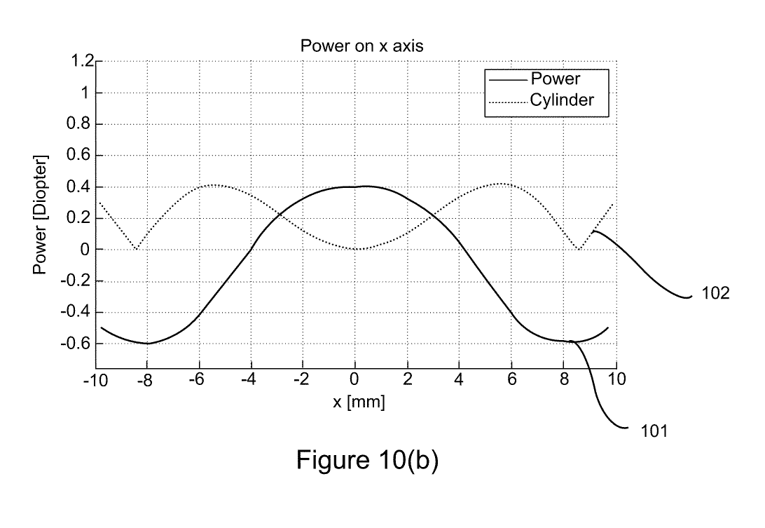

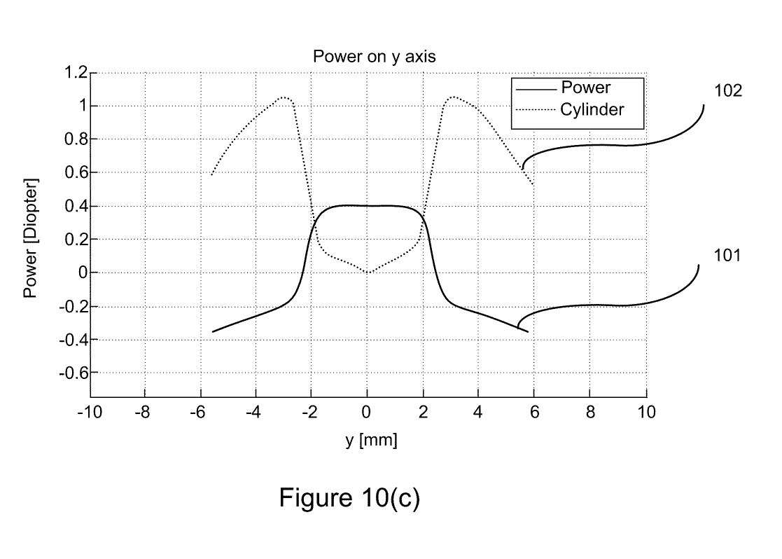

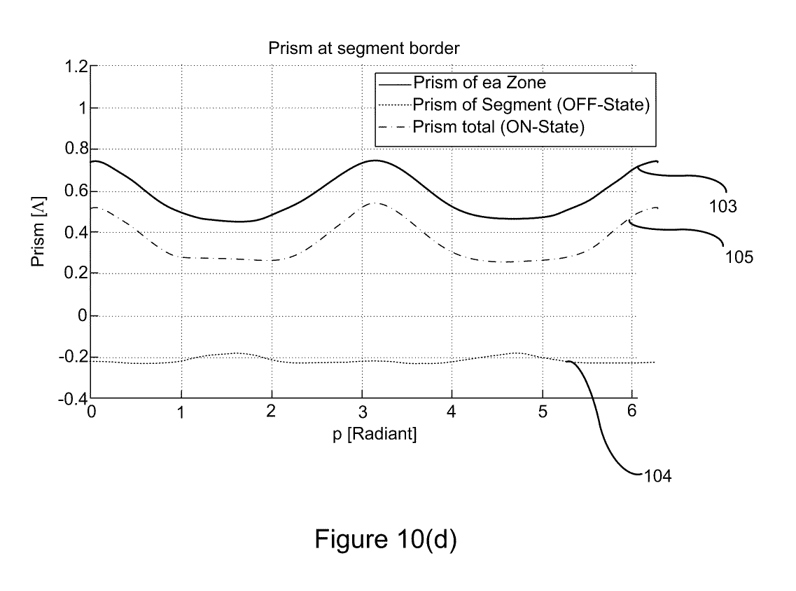

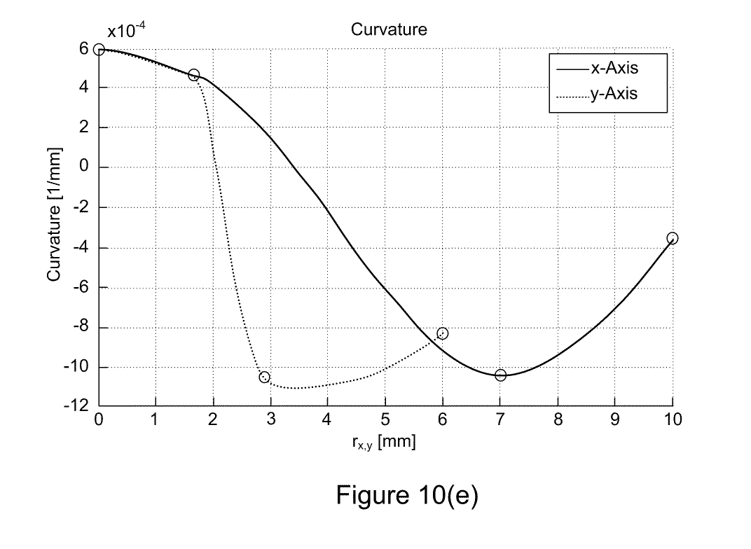

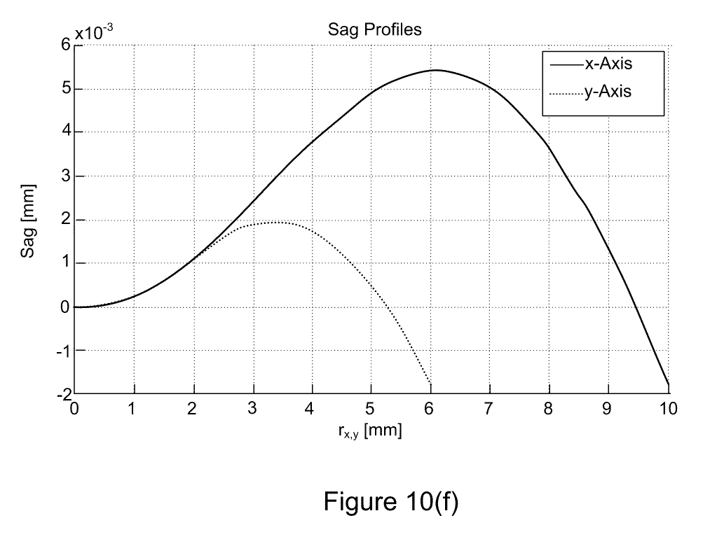

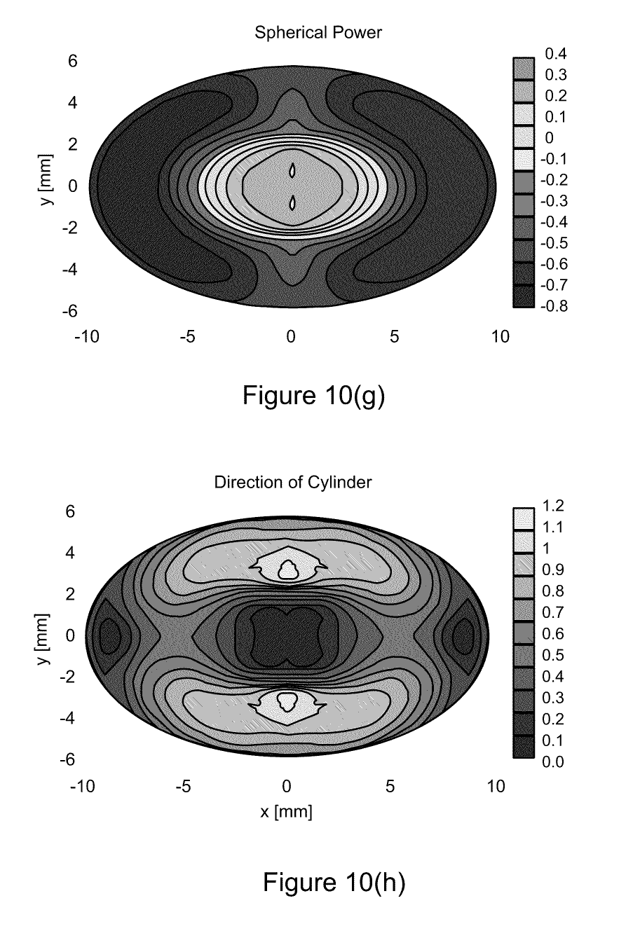

For the exemplary embodiment disclosed in FIGS. 10(a)-(h):

| | |
|---|---|
| Prism of Segment on x-Axis = −0.2167 | on y-Axis = −0.1774 |
| Power at Center = 0.3894 | |
| Cylinder at Center = 0.0041 | |
| Power at border on x-Axis = −0.4588 | on y-Axis = −0.3429 |

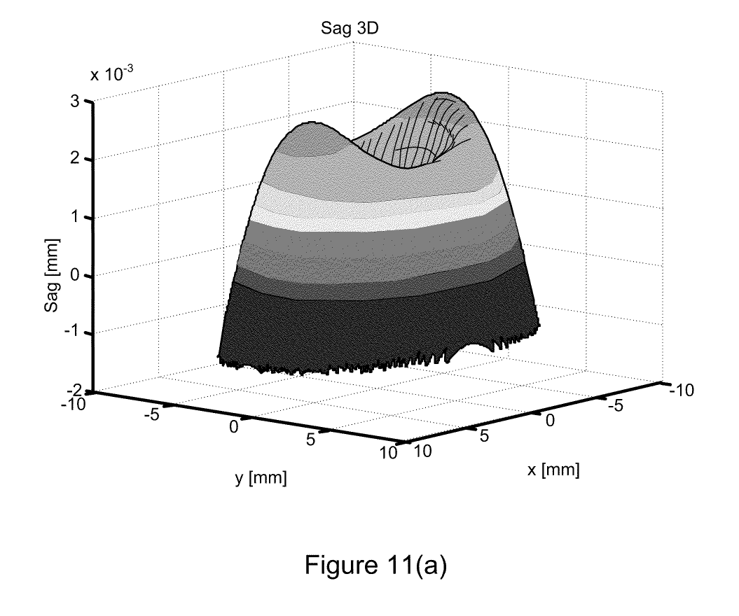

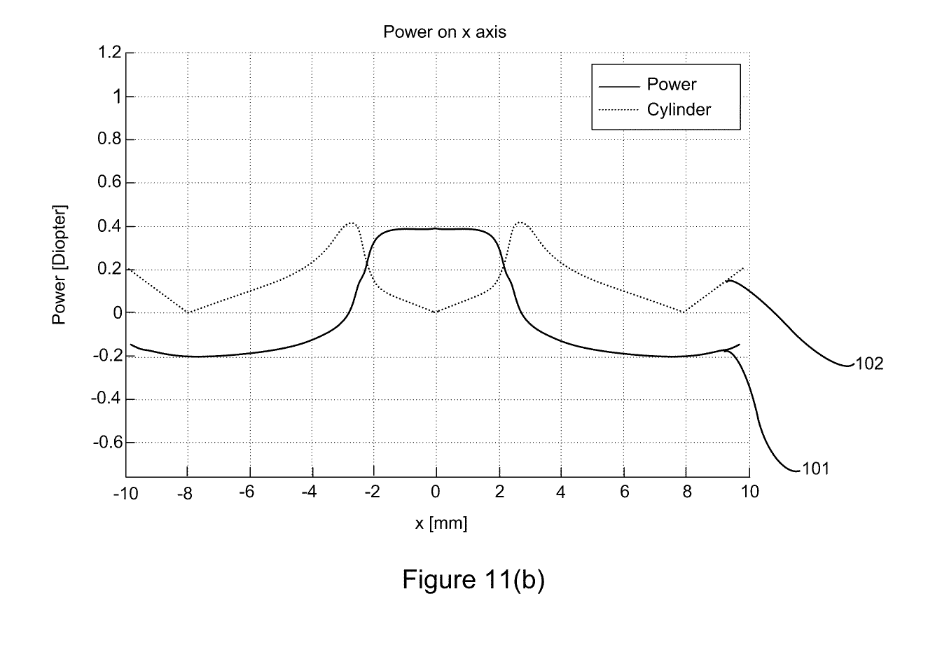

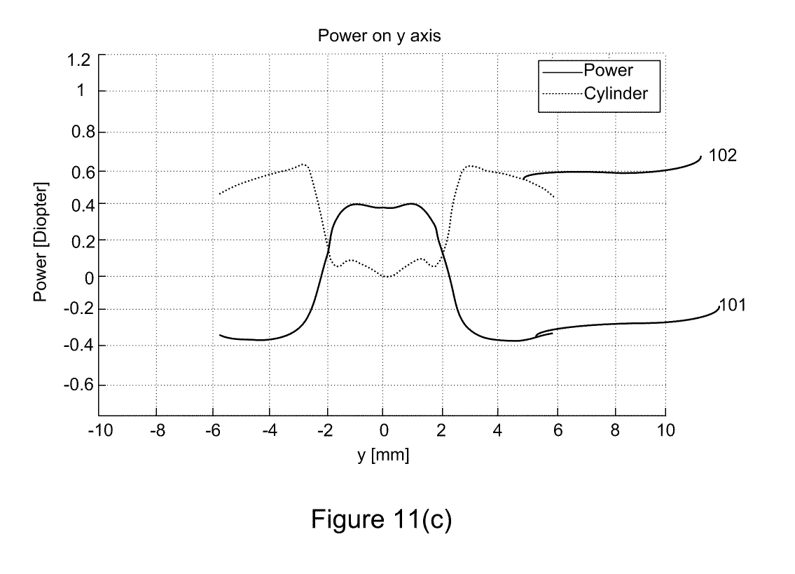

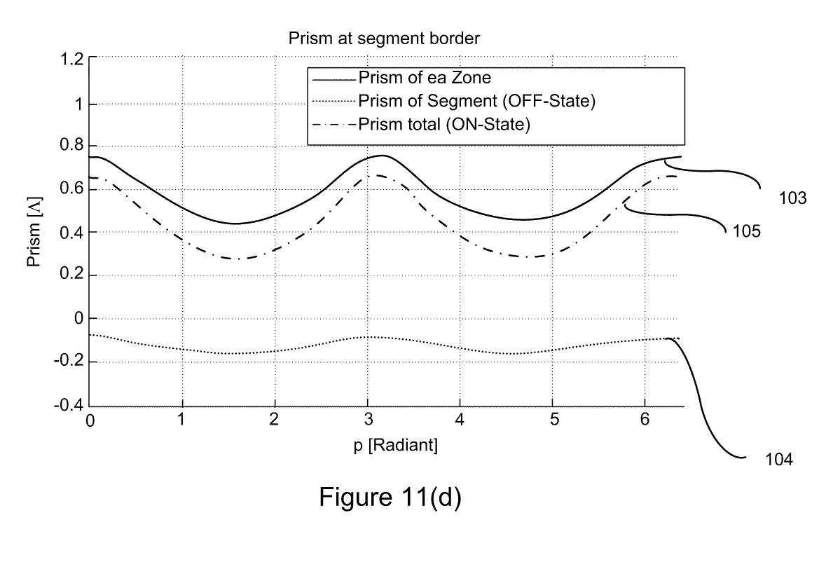

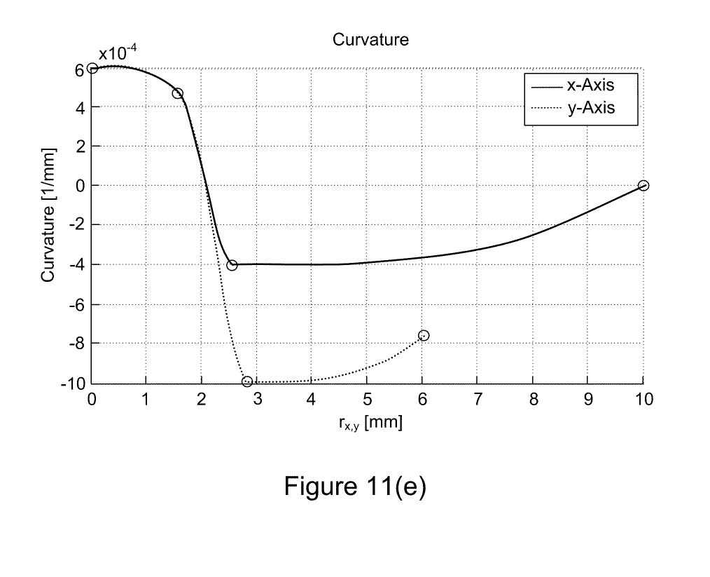

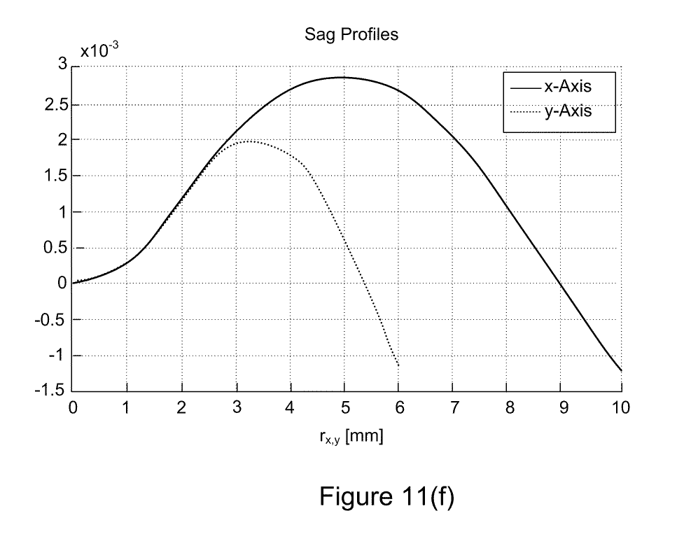

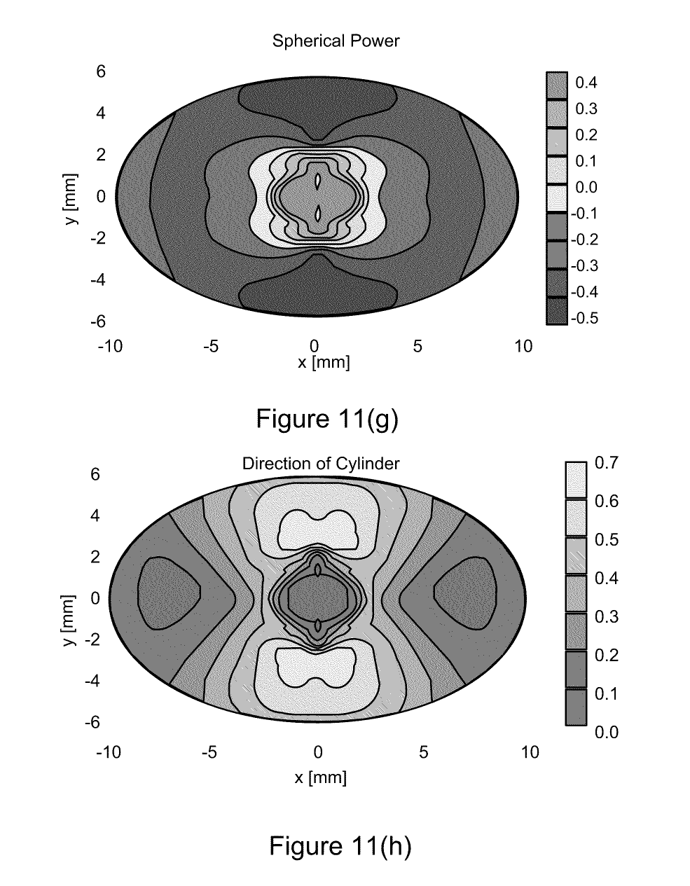

For the exemplary embodiment disclosed in FIGS. 11(a)-(h)

| | |
|---|---|
| Prism of Segment on x-Axis = −0.0837 | on y-Axis = −0.1561 |
| Power at Center = 0.3894 | |
| Cylinder at Center = 0.0042 | |
| Power at border on x-Axis = −0.1332 | on y-Axis = −0.3215 |

The exemplary embodiments show that the static power zone may have a dual function, in some embodiment—(1) it can augment the total power of the add power zone relative to the power of the dynamic power zone, and (2) it can reduce image jump at the periphery of the dynamic power zone. Moreover the optical design algorithm may enable optimization of astigmatism relative to image jump at the periphery. Such an algorithm involves minimization of a merit function that expresses astigmatism over the overall static zone for different levels of image jump and selects the magnitude of image jump that minimizes astigmatism over the static zone as a whole. However, as was noted above, the optimum power profile depends on many factors, including the magnitude of the dynamic power zone and the geometry of the dynamic power zone.

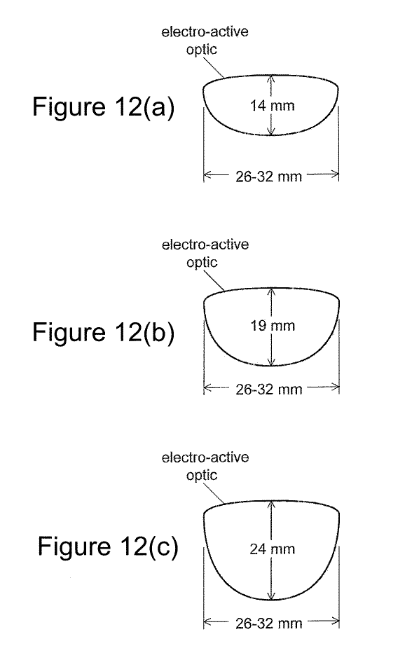

FIGS. 12(a)-12(c) show embodiments of a multi-focal lens. In the embodiments shown, the multi-focal lens has an oval shape and is between approximately 26 mm and approximately 32 mm wide. Various heights of the multi-focal lens are shown. FIG. 12(a) shows a multi-focal lens with a height of approximately 14 mm. FIG. 12(b) shows a multi-focal lens with a height of approximately 19 mm. FIG. 12(e) shows a multi-focal lens with a height of approximately 24 mm. However, any suitable shape or size may be used.

### Electro Active Embodiments

As noted above, in some embodiments the dynamic lens or segment may be an electro-active element. It should be understood, however, that the invention is not so limited and may utilize any type of dynamic lens. In an electro-active lens embodiments, an electro-active optic may be embedded within or attached to a surface of an optical substrate. The optical substrate may be a finished, semi-finished or unfinished lens blank. When a semi-finished or unfinished lens blank is used, the lens blank may be finished during manufacturing of the lens to have one or more optical powers. An electro-active optic may also be embedded within or attached to a surface of a conventional optical lens. The conventional optical lens may be a single focus lens or a multifocal lens such as a Progressive Addition Lens or a bifocal or trifocal lens. The electro-active optic may be located in the entire viewing area of the electro-active lens or in just a portion thereof. The electro-active optic may be spaced from the peripheral edge of the optical substrate for edging the electro-active lens for spectacles. The electro-active element may be located near the top, middle or bottom portion of the lens. When substantially no voltage is applied, the electro-active optic may be in a deactivated state in which it provides substantially no optical power. In other words, when substantially no voltage is applied, the electro-active optic may have substantially the same refractive index as the optical substrate or conventional lens in which it is embedded or attached. When voltage is applied, the electro-active optic may be in an activated state in which it provides optical add power. In other words, when voltage is applied, the electro-active optic may be “tuned” or “switched” so as to have a different refractive index than the optical substrate or conventional lens in which it is embedded or attached.

Electro-active lenses may be used to correct for conventional or non-conventional errors of the eye. The correction may be created by the electro-active element, the optical substrate or conventional optical lens or by a combination of the two. Conventional errors of the eye include low order aberrations such as near-sightedness, far-sightedness, presbyopia, and astigmatism. Non-conventional errors of the eye include higher-order aberrations that can be caused by ocular layer irregularities.

Liquid crystal may be used as a portion of the electro-active optic as the refractive index of a liquid crystal can be changed by generating an electric field across the liquid crystal. Such an electric field may be generated by applying one or more voltages to electrodes located on both sides of the liquid crystal. The electrodes may be substantially transparent and manufactured from substantially transparent conductive materials such as Indium Tin Oxide (ITO) or other such materials which are well-known in the art. Liquid crystal based electro-active optics may be particularly well suited for use as a portion of the electro-active optic since the liquid crystal can provide the required range of index change so as to provide optical add powers of piano to +3.00 D. This range of optical add powers may be capable of correcting presbyopia in the majority of patients.

As noted above, each of the dioptric powers, curvature radii, any dimension, and refractive index provided herein as examples are just examples only and are not intended to be limiting. Embodiments disclosed herein can provide any and all distance vision corrective optical power and add optical power needed or required for the wearer's optical needs. This can be accomplished, for example, by choosing the proper curves required of a first (e.g. front) surface, a second (e.g. back) surface, external surface curve of any included optical feature, and the appropriate thickness and refractive index as needed for the first lens component. Further and as noted above, embodiments of the dynamic lens can be that of a lens, a lens blank that is finished on both sides, or a semi-finished lens blank that must be one of free formed or digitally surfaced, or surfaced and polished into a final finished lens.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment can be combined with one or more features of any other embodiment without departing from the scope of the invention.

A recitation of “a”, “an” or “the” is intended to mean “one or more” unless specifically indicated to the contrary

What is claimed is:

1. An apparatus comprising:
a dynamic power zone having a periphery;
a static power zone in optical communication with at least a portion of the dynamic power zone, wherein the static power zone has a negative optical power at a first portion of the periphery of the dynamic power zone.

2. The apparatus of claim 1, wherein the static power zone has a positive optical power approximately at the center of the dynamic power zone.

3. The apparatus of claim 1, wherein the optical power profile of the static power zone is asymmetric.

4. The apparatus of claim 1, wherein the static power zone has a minimum optical power within 5 mm from the periphery of the dynamic power zone in a direction perpendicular to the periphery.

5. The apparatus of claim 4, wherein the static power zone has a minimum optical power within 1 mm from the periphery of the dynamic power zone in a direction perpendicular to the periphery.

6. The apparatus of claim 1, wherein the first portion of the periphery of the dynamic power zone comprises a portion of the periphery of the dynamic power zone between a near and a far distance viewing zone.

7. The apparatus of claim 1, wherein the first portion of the periphery of the dynamic power zone includes only a portion of the periphery of the dynamic power zone between a near and a far distance viewing zone.

8. The apparatus of claim 1, wherein the first portion of the periphery of the dynamic power zone comprises the entire periphery of the dynamic power zone.

9. The apparatus of claim 1, wherein the dynamic power zone comprises an electro-active segment.

10. The apparatus of claim 1, wherein the static power zone is aspheric.

11. The apparatus of claim 1, wherein the static power zone and the dynamic power zone have a similar shape.

12. The apparatus of claim 1, wherein the static power zone and the dynamic power zone have the same shape.

13. The apparatus of claim 1, wherein the static power zone and the dynamic power zone are coupled to an ophthalmic lens optic.

14. The apparatus of claim 1, wherein a total add power of the dynamic power zone and the static power zone at the first portion of the periphery of the dynamic power zone when the dynamic power zone is in an active state is less than approximately 1 Diopter.

15. The apparatus of claim 14, wherein a total add power of the dynamic power zone and the static power zone at the first portion of the periphery of the dynamic power zone when the dynamic power zone is in an active state is less than approximately 0.5 Diopters.

16. The apparatus of claim 1, wherein the static power zone has a minimum optical power at the first portion of the periphery of the dynamic power zone of approximately −1 Diopter.

17. The apparatus of claim 1, wherein the static power zone has an optical power at the first portion of the periphery of the dynamic power zone approximately within the range of −0.1 to −0.8 Diopters.

18. The apparatus of claim 1, wherein the static power zone provides a discontinuous change in optical power at the first portion of the periphery of the dynamic power zone.

19. The apparatus of claim 1, wherein the static power zone provides a continuous change in average spherical optical power and astigmatism at the first portion of the periphery of the dynamic power zone.

20. The apparatus of claim 1, wherein the static power zone comprises a progressive addition surface.

21. The apparatus of claim 1, wherein the total prism jump from the dynamic power zone and the static power zone at the first portion of the periphery of the dynamic power zone when the dynamic power zone is in an active state is less than approximately 0.5 Diopters.

22. The apparatus of claim 1, wherein the maximum total add power of the static power zone and the dynamic power zone when the dynamic power zone is in an active state is at least 1.5 Diopters.

23. An ophthalmic lens comprising a dynamic electro-active segment having a first add optical power and a static addition zone having a second add optical power, wherein the static addition zone comprises a progressive addition surface that contributes a positive optical power and a minus optical power.

24. The ophthalmic lens of claim 23, wherein the static addition zone has at least a first portion in optical communication with at least a portion of the periphery of the dynamic electro-active segment.

25. The ophthalmic lens of claim 24, wherein the first portion of the static addition zone has a negative optical power.

26. The ophthalmic lens of claim 25, wherein the total add optical power of the first portion of the static addition zone and the portion of the periphery of the dynamic electro-active segment when the dynamic electro-active segment is activated is less than 1 Diopter.

27. The ophthalmic lens of claim 26, wherein the static addition zone and the dynamic electro-active segment have a similar shape and are located in approximately the same 100 location on the ophthalmic lens.
